(19) United States
(12) Patent Application Publication
(10) Pub. No.: US 2023/0294093 A1
(43) Pub. Date: Sep. 21, 2023

(54) DIGITAL MICROFLUIDICS CARTRIDGE DEVICE AND SYSTEM

(71) Applicant: Colorado State University Research Foundation, Fort Collins, CO (US)

(72) Inventors: Thomas Chen, Fort Collins, CO (US); Nicholas Grant, Fort Collins, CO (US)

(21) Appl. No.: 18/186,597

(22) Filed: Mar. 20, 2023

Related U.S. Application Data
(60) Provisional application No. 63/321,464, filed on Mar. 18, 2022.

(51) Int. Cl. B01L 3/00

(52) U.S. Cl. CPC B01L 3/502715; B01L 3/50273; B01L 3/502738; B01L 2300/0816; B01L 2400/0487; B01L 2300/0636; B01L 2300/087; B01L 2400/06; B01L 2400/043; B01L 2400/0496; B01L 2200/16

(57) ABSTRACT

An exemplary system and method are disclosed for a digital microfluidic chip cartridge and system configured for electro-wetting on dielectric (EWOD) microfluidic operations and experimental analysis. The exemplary portable lab-on-a-chip devices and systems can be configured to execute complex assays such as DNA isolation employing integrated sensor and electronics can analyze results. The EWOD or digital microfluidic cartridge can be configured with customizable assays having preloaded reagents targeted specifically for a given assay that can be used in an analysis in the field (i.e., point of care, i.e., not in a central laboratory) using a disposable or recyclable assay cartridge system. The cartridge and portable instrument can operate on specific instructions based on the algorithm intended for the assay.

### RELATED APPLICATION

This application claims priority to, and the benefit of, U.S. Provisional Patent Application No. 63/321,464, filed Mar. 18, 2022, entitled “PORTABLE AND BATTERY-OPERATED DIGITAL MICROFLUIDICS DEVICE,” which is hereby incorporated by reference herein in its entirety.

### BACKGROUND

At micro volumes, fluids can behave differently from conventional fluid dynamics. It has been observed that mixing two micro-volumes of fluids is not convective as in bulk fluids; rather, they may not mix at all and can flow in a laminar fashion when bought together in a channel. The movement can be characterized by the ratio of inertial to viscous forces on fluids, namely, via the Reynolds number (Re). Electrowetting is a change in the wettability of a fluid via the application of an applied electric potential. Electrowetting has two types: direct electrowetting (where the fluid is in direct contact with the electrode) and electrowetting on dielectric (EWOD) (where an insulating layer is employed between the electrode and fluid).

Sample preparation can be very time-consuming and costly, particularly when the application employs many reagents, which is often the case for many medical diagnostic applications. The complexity of human-involved sample preparations also requires sophisticated lab equipment for dispensing and mixing. Microfluidic technologies, such as Electro-wetting on Dielectric, offer many advantages to the Point-of-Care (POC) devices through lower reagent use and smaller size. Additionally, Point-of-Care devices offer the unique potential to conduct tests outside of the laboratory.

While electro-wetting on dielectric (EWOD) microfluidics, direct electrowetting, and digital microfluidics has been shown to be an effective way to move and mix liquids enabling many PoC devices, much of the research surrounding these lab-on-a-chip microfluidic systems are focused on droplet control or a specific new application at the device level using the EWOD technology. Often in these experiments, the supporting systems required for operation are benchtop equipment such as function generators, power supplies, and personal computers.

There is a benefit and/or a need to improve microfluidics devices and their usage.

### SUMMARY

An exemplary system and method are disclosed for a digital microfluidic chip cartridge and system configured for electro-wetting on dielectric (EWOD) microfluidic operations and experimental analysis. The exemplary portable lab-on-a-chip devices and systems can be configured to execute complex assays such as DNA isolation employing integrated sensors and electronics that can analyze results. The EWOD or digital microfluidic cartridge can be configured with customizable assays having preloaded reagents targeted specifically for a given assay that can be used in an analysis in the field (i.e., point of care, i.e., not in a central laboratory) using a disposable or recyclable assay cartridge system. The cartridge and portable instrument can operate on specific instructions based on the algorithm intended for the assay.

The portable instrument can be fully self-contained, having a driving circuit configured to actuate the conductive tiles to move or mix the fluid along a fluidic plate. The cartridge device and associated system may have local and system-level self-testing circuit operations configured to assess operative contact between a conductive tile array and driving circuits. The EWOD or digital microfluidic cartridge may include field-enhancing structures to improve the reliability of the electro-wet or digital microfluidic operations. The EWOD or digital microfluidic cartridge may employ a hydrophobicity-effect-based micro-valve that can operate purely with electrical actuation and without pneumatics, reducing the complexity, cost, and reliability of the portable instrument.

In an aspect, a system is disclosed comprising a base system and a cartridge couplable to the base system. The cartridge includes: a housing; a microfluidic electrode assembly comprising: a fluidic plate (e.g., microfluidic plate) having two or more mixing/testing regions; a set of conductive tiles disposed along the fluidic plate that connects between the two or more mixing/testing regions, wherein the set of conductive tiles (e.g., pads) terminates at a set of a corresponding conductive-tile array located at an interface region on the fluidic plate; a self-testing circuit (e.g., disposed on a separate electronic board or disposed on the fluidic plate) having electronics configured to assess operative contact between (i) the conductive-tile array and (ii) driving circuits configured to actuate the set of conductive tiles to move or mix fluid along the fluidic plate.

In some embodiments, the system further includes at least one sensing tile (e.g., sensor) disposed along the fluidic plate adjacent to or integrated with the set of conductive tiles, wherein the at least one sensing tile terminates either (i) at the set of a corresponding conductive-tile array or (ii) a second set of a conductive-tile array, the self-testing circuit being configured to also assess operative contact of the conductive-tile array associated with the sensing tile.

In some embodiments, the system further includes a biosensor (e.g., electrochemical, impedimetric, or capacitive sensor) disposed (i) along the fluidic plate between two or more conductive tiles of the set of conductive tiles or (ii) inside one of the two or more mixing/testing regions (e.g., a reservoir well), wherein the biosensor electrically terminates either (i) at the set of a corresponding conductive-tile array or (ii) a second set of the conductive-tile array, the self-testing circuit being configured to also assess operative contact of the conductive-tile array associated with the biosensor.

In some embodiments, the system further includes a dielectric material disposed between elements of the set of conductive tiles (e.g., low-strength dielectric fill to planarize the surface and remove the air gap).

In some embodiments, the system further includes a magnetic focusing region for the fluidic plate or the set of conductive tiles, the magnetic focusing region being defined by a field from a magnet (e.g., a traditional magnet, an electromagnetic coil, or a programmable coil array) and a magnetic focusing structure disposed adjacent or in proximity to the magnetic region (e.g., underneath the fluidic plate).

In some embodiments, the magnetic focusing structures comprises a magnetic field guide (e.g., disposed underneath the fluidic plate and configured to redirect magnetic fields from the magnet to a desired location on the fluidic plate or the set of conductive tiles).

In some embodiments, the two or more mixing/testing regions include a sample reservoir, an outlet reservoir, and at least one intermediate reservoir, each disposed adjacent to or along the set of conductive tiles or the interface region of the fluidic plate (e.g., wherein the sample reservoir includes a sample solution).

In some embodiments, the at least one intermediate reservoir comprises a pre-configured buffer solution (e.g., housed in an integrated package assembly) to be introduced into one of the two or more mixing/testing regions.

In some embodiments, the at least one intermediate reservoir comprises a reagent (e.g., housed in an integrated package assembly) to be introduced into one of the two or more mixing/testing regions for mixing with the sample solution.

In some embodiments, the at least one intermediate reservoir comprises an intermediate buffer solution (e.g., Tris Buffer, MES Buffer, PNI Buffer, PE Buffer, or EB Buffer solution).

In some embodiments, the sample reservoir, the outlet reservoir, or the at least one intermediate reservoir is adjacent to the interface region on the fluidic plate.

In some embodiments, the system further includes an electrically-actuated non-mechanically moving valve (e.g., a hydrophobic valve) disposed (i) along the set of conductive tiles or (ii) mixing/testing regions, the electrically-actuated non-mechanically moving valve configured to restrict a fluid flow across the valve in a natural un-actuated state and allow the flow of fluid across the valve when actuated (e.g., wherein one of the first configuration or the second configuration comprises application of an electric potential or current).

In some embodiments, the base system includes: a microcontroller in electrical communication with the cartridge; and a memory (e.g., storing a number of assay protocols selectable by a user) in electrical communication with the microcontroller; and a display interface and/display (e.g., OLED screen) in electrical communication with the microcontroller and configured to display information about the system.

In some embodiments, the intermediate reservoir includes an integrated package assembly disposed on the fluidic plate, the integrated package assembly having (i) a first region to hold a reagent or fluid and (ii) a second region to hold an intermediate storage fluid, the integrated package assembly having a removable or pierceable covering configured, (i) in a non-removed or non-pierced state, to maintain negative pressure at the first region and (ii) in a removed or pierced state to allow the storage fluid to move to the first region while the reagent or fluid move to the second region to contact the fluidic plate.

In some embodiments, the system is configured to perform one of: (i) a DNA isolation protocol with an immobilized filter or (ii) a DNA isolation protocol with magnetic beads.

In another aspect, a method for self-testing a circuit is disclosed, the method comprising: providing a cartridge comprising a microfluidic electrode assembly comprising fluidic plate and a set of conductive tiles disposed along the fluidic plate; inserting the cartridge into a base system (e.g., the base unit of the device, or some other intermediary base system/connection point in the manufacturing process or QA process); assessing operative contact between one of (i) the microfluidic electrode assembly of the cartridge or (ii) the set of conductive tiles and corresponding contact points on the base system; and signaling an error if one or more contact points are disconnected or incompletely connected to the microfluidic electrode assembly cartridge.

In some embodiments, the assessing is performed during run-time of the cartridge.

In some embodiments, the assessing is performed during the manufacturing step of the cartridge.

In some embodiments, the method further includes recycling or reusing a cartridge upon completion of a testing operation.

In another aspect, a cartridge is disclosed, the cartridge configured to couple to a base system, the cartridge comprising: a housing; a microfluidic electrode assembly comprising: a fluidic plate (e.g., microfluidic plate) having two or more mixing/testing regions; a set of conductive tiles disposed along the fluidic plate that connects between the two or more mixing/testing regions, wherein the set of conductive tiles (e.g., pads) terminates at a set of corresponding conductive-tile array located at an interface region on the fluidic plate; a self-testing circuit (e.g., disposed on a separate electronic board or disposed on the fluidic plate) having electronics configured to assess operative contact between (i) the conductive-tile array and (ii) driving circuits configured to actuate the set of conductive tiles to move or mix fluid along the fluidic plate.

### BRIEF DESCRIPTION OF THE DRAWINGS

The skilled person in the art will understand that the drawings described below are for illustration purposes only.

FIGS. 1A and 1B illustrate an example of a portable and batter-operated digital microfluidics system, according to one implementation.

FIG. 2 illustrates an example of an exploded view of the cartridge, according to one implementation.

FIGS. 3A-3D illustrate a microfluidic chip configured, e.g., as an electro-wetting on dielectric (EWOD) chip or digital microfluidic chip, according to various implementations.

FIGS. 4A and 4B, respectively, shows a cross-sectional operation of a microfluidic electrode assembly with and without the magnetic field focusing assembly, according to various implementations.

FIG. 4C illustrates a feature of the conductive-tile array to improve the electrowetting operation using a dielectric infill, according to various implementations.

FIGS. 5A-5D illustrate example circuitry for the driving circuits, according to various implementations.

FIG. 5E illustrate example circuitry for the built-in testing circuits, according to various implementations.

FIGS. 6A and 6B show an example configuration and operation of the passive reagent storage and packaging, e.g., for the microfluidic chip of FIGS. 1-5, according to one implementation.

FIGS. 7A-7P show an example design and construction of a non-mechanical hydrophobic valve that may be employed in the microfluidic chip of FIGS. 1-6, according to one implementation.

FIGS. 8A-8D show experimental for a microfluidic chip configured with the hydrophobic valve.

### DETAILED DESCRIPTION

Each and every feature described herein, and each and every combination of two or more of such features, is included within the scope of the present disclosure, provided that the features included in such a combination are not mutually inconsistent.

The citation and/or discussion of such references is provided merely to clarify the description of the present disclosure and is not an admission that any such reference is “prior art” to any aspects of the present disclosure described herein. In terms of notation, “[n]” corresponds to the nth references in the list. All references cited and discussed in this specification are incorporated herein by reference and to the same extent as if each reference was individually incorporated by reference.

Example System

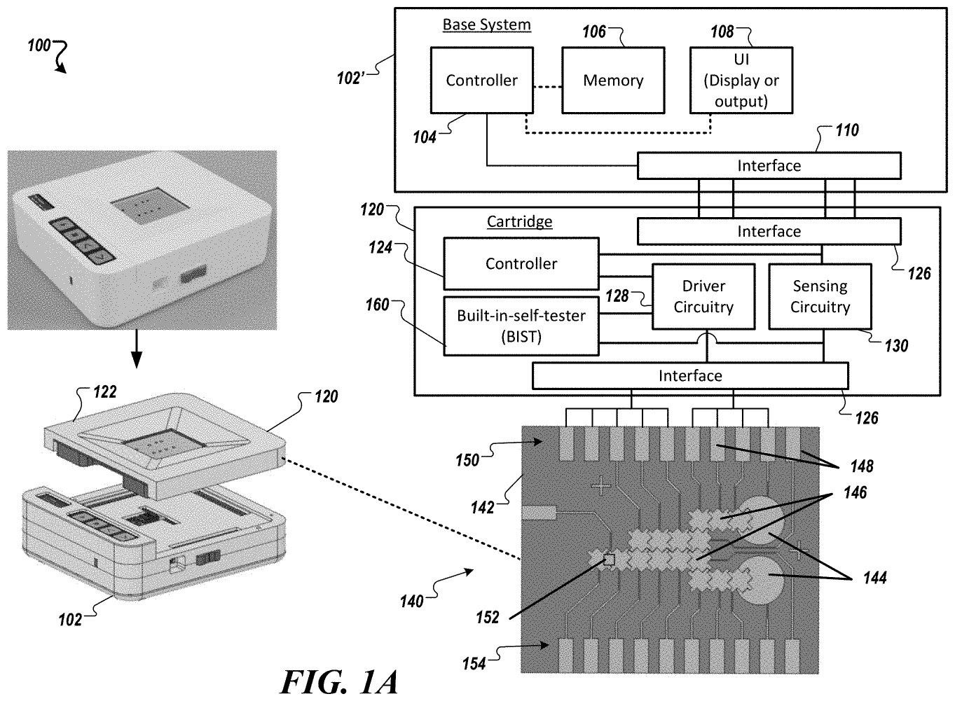

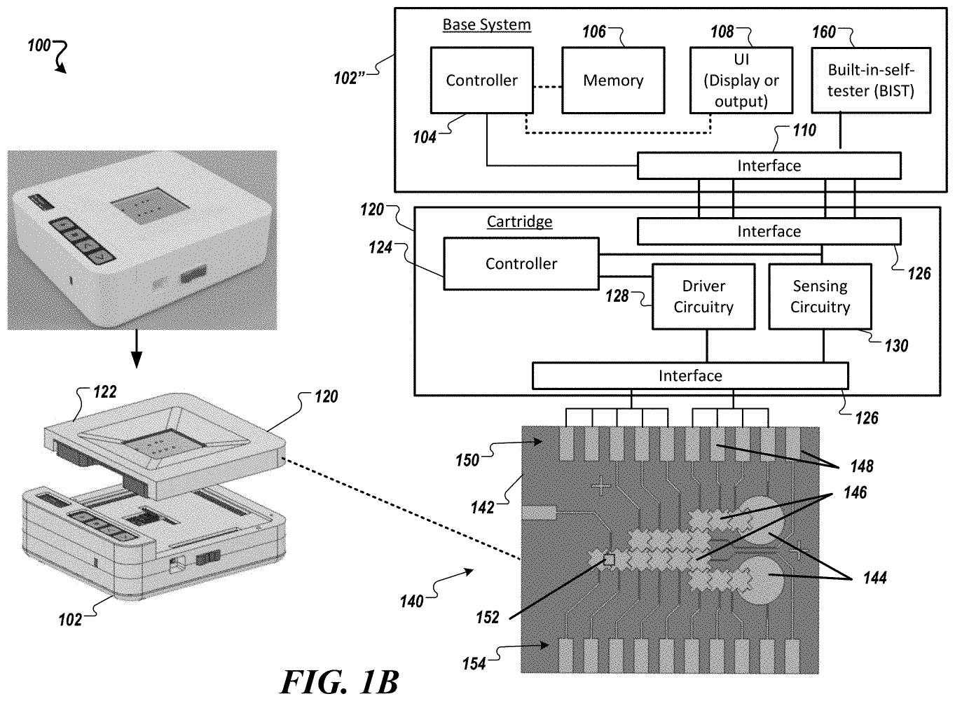

FIG. 1A illustrates an example portable digital microfluidics system 100 (e.g., battery-operated) capable of executing complex assays (e.g., DNA isolation). The system 100 includes a base instrument system 102 (also interchangeably referred to herein as a base system 102) and a cartridge 120 having mechanical and electrical interface couplable to the base instrument system 102. In the example shown in FIG. 1A, the base instrument system 102 (shown as 102′) includes an instrument controller 104, an instrument memory 106, an instrument user interface 108 (e.g., display or output for UI), and an instrument interface 110 to couple to the cartridge 120.

The instrument controller 104 is operatively connected to the instrument memory 106, the instrument UI output or display 108, and the instrument interface 110. The instrument UI output or display 108, when configured as a display, may include a touchscreen, push buttons, and/or a digital display.

The controller 104 may employ any processing circuitry (for example, but not limited to, an application-specific integrated circuit (ASIC), microcontrollers, microprocessors, complex programmable logic device (CPLD), field-programmable gate array (FPGA), and/or a central processing unit (CPU)). In some examples, the processing circuitry may be electrically coupled one or more sensor arrays, a memory (such as, for example, random access memory (RAM) for storing computer program instructions), and/or a display circuitry.

In some examples, one or more of the procedures may be embodied by computer program instructions, which may be stored by a memory (such as a non-transitory memory) of a system employing an embodiment of the present disclosure and executed by a processing circuitry (such as a processor) of the system. These computer program instructions may direct the system to function in a particular manner, such that the instructions stored in the memory circuitry produce an article of manufacture, the execution of which implements the function specified in the flow diagram step/operation(s). Further, the system may comprise one or more other circuitries. Various circuitries of the system may be electronically coupled between and/or among each other to transmit and/or receive energy, data, and/or information.

In some examples, embodiments may take the form of a computer program product on a non-transitory computer-readable storage medium storing computer-readable program instruction (e.g., computer software). Any suitable computer-readable storage medium may be utilized, including non-transitory hard disks, CD-ROMs, flash memory, optical storage devices, or magnetic storage devices.

Referring still to FIG. 1A, the cartridge 120 (shown as 120′) is configured as a disposable or recyclable assay cartridge and includes a cartridge housing 122, a microfluidic electrode assembly 140, and electronics that couple to the microfluidic electrode assembly 140. The electronics in the example include a cartridge controller 124, a cartridge interface 126, driver circuitry 128, sensing circuitry 130, and a self-testing circuit 160.

In this example, the cartridge controller 124 is operatively coupled to the driver circuitry 128, sensing circuitry 130, and the cartridge interface 126. The connection may be direct or indirect. The cartridge interface 126 is operatively coupled to the instrument interface 110 to facilitate communication between the instrument system 102 and the electronics of the cartridge 120. The sensing circuitry 130 is operatively coupled to the cartridge interface 126 and/or the controller. The built-in-self-tester, or self-testing circuit 160, is operatively coupled to the driver circuitry 128 and/or the cartridge interface 126.

In this example, the cartridge controller 124 and the built-in self-tester 160 are shown implemented in different components. In other embodiments, the built-in-self-tester may be implemented in the cartridge controller 124. Similarly, the cartridge controller 124 may include integrated front-end analog circuitries for sensing or driving output as well as digital communication or memory interface, among others. Examples of sensing and driving circuitries are provided later herein.

Micro fluidic Electrode Assembly. Referring to FIG. 1A, the micro-fluidic electrode assembly 140 is coupled to or held within the cartridge 120 by a portion of the housing 122. The micro-fluidic electrode assembly 140 includes a fluidic plate 142 (e.g., a microfluidic plate) having two or more reservoir, mixing, or testing regions 144. The micro-fluidic electrode assembly 140 also includes a set of conductive tiles 146 disposed along the fluidic plate 142 that connect between the two or more reservoir, mixing, and/or testing regions 144. The set of conductive tiles 146 (e.g., conductive pads) terminate at a set of corresponding conductive-tile array 148 located at an interface region 150 on the fluidic plate 142. The set of corresponding conductive-tile array 148 is configured to be coupled to the cartridge interface 126 to facilitate communication between the cartridge 120 and the microfluidic electrode assembly 140. The conductive-tile array 148 serves as the connection point of the driving and sensing electronics of the cartridge (e.g., 120).

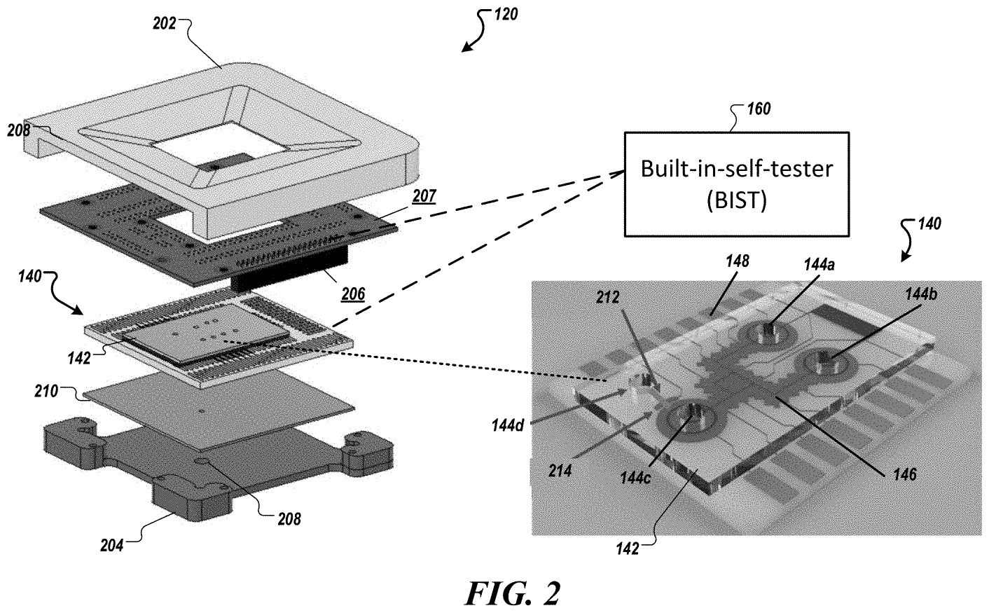

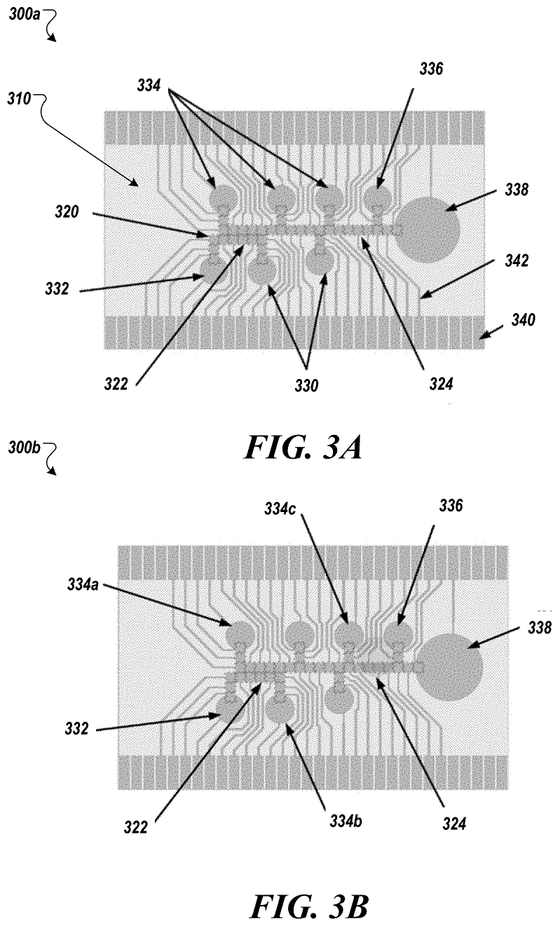

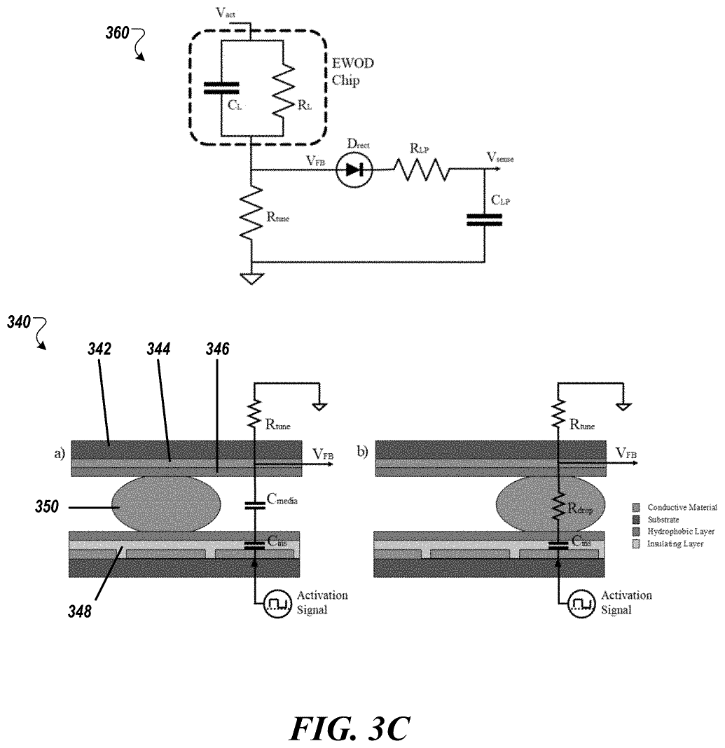

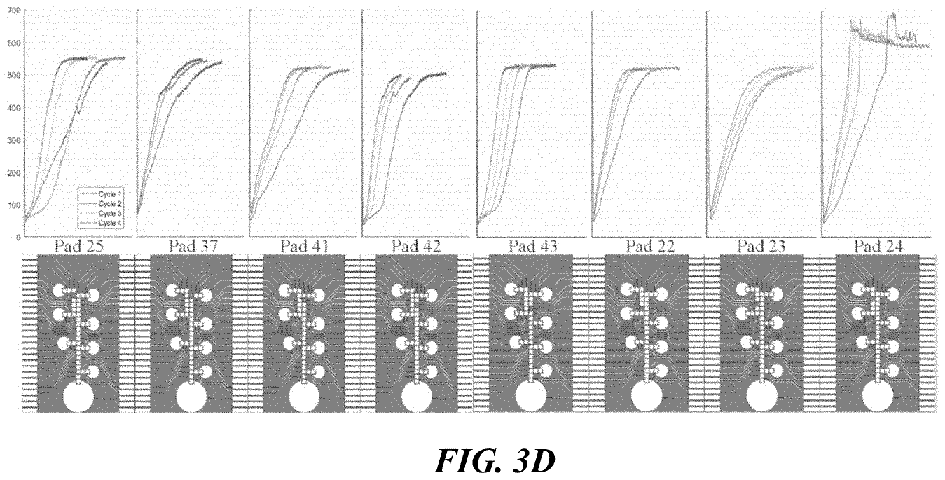

In the example shown in FIG. 2, the micro-fluidic electrode assembly 140 (shown as 140a) includes reservoir regions 144a, 144b and a testing/missing region 144c, 144d. In the example shown in FIGS. 3A and 3B, the micro-fluidic electrode assembly 140 (shown as 300a) includes reservoir regions 144a, 144b and a testing/mixing region 144c. It is contemplated at the electrowetting application can move samples, reagents, and various solutions in a forward or backward direction. To this end, the reservoir, testing, and mixing regions can be implemented flexibly and the various regions can be used for more than one purpose.

Referring still to FIG. 1A, the conductive-tile array 146 connects to the reservoir, mixing, and/or testing regions 144 to provide sensing or actuation of that region. Different topologies for the sensing or actuation may be employed. Examples are described in U.S. Publication No. 2020-0324289 A1, which is incorporated by reference herein in its entirety.

In some implementations, the micro-fluidic electrode assembly 140 includes a plurality of sensors; for example, at least one sensing tile 152 disposed along the fluidic plate 142 adjacent to or integrated with the set of conductive tiles 146. The sensing tile 152 may terminate at the set of corresponding conductive-tile array 148, or a second set of conductive tile array 154. The sensor may be deployed for analysis acquisition or may be deployed to confirm proper operation of the electrowetting or digital microfluidic operations, e.g., in moving fluids within the assembly 140.

In either configuration (for sensing or control), the micro-fluidic electrode assembly 140 may include at least one biosensor (e.g., electrochemical, impedimetric, or capacitive sensor) disposed along the fluidic plate 142 between two or more conductive tiles of the set of conductive tiles 146, or inside one of the two or more reservoir, mixing, and/or testing regions 144. The biosensor may electrically terminate either (i) at the set of corresponding conductive-tile array 148 or (ii) at a second set of conductive-tile array 154. In some implementations, multiple sensing tiles or biosensors are placed on the fluidic plate along the set of conductive tiles and/or within the two or more mixing/testing regions.

Built-in Self Tester. In use, the cartridge 120 is coupled to the instrument system 102. The self-testing circuit 160 includes electronics configured to assess operative contact between the conductive-tile array 148 of the microfluidic electrode assembly 140 and the driving circuits 128 of the cartridge 120. For example, each one of the tiles of the conductive-tile array 148 may contact and communicate with corresponding electric contact points on the cartridge interface 126. Then, each contact point on the cartridge interface 126 may contact and communicate with corresponding contact points of the base interface 110. In the end, each conductive tile 148 and other elements of the microfluidic electrode assembly 140 and of the cartridge 120 as a whole can communicate with the instrument system 102. The self-testing circuit 160 assesses operative contact between these elements to ensure proper communication. In some implementations, the self-testing circuit 160 can be configured to assess operative contact of the conductive-tile array 148 with the sensing tile 152.

In some embodiments, the built-in self-tester 160 is configured to send a test signal into the set of controllable conductive-tiles in an array (e.g., 148) located on the micro-fluidic electrode assembly 140 and sense, for example, the connectivity of the connected load, to verify the proper electrical connection between the driving circuitry 128 and the corresponding control element of the electrowetting tiles. The corresponding conductive-tile array 148 can be a highly dense connector of conductive elements that can be formed on a material different from the connector. The built-in self-tester 160 ensures that the numerous electrical connections required between the micro-fluidic electrode assembly 140 and the corresponding electronics in the cartridge (e.g., 120) is properly established. The built-in self-tester 160 is configured, in some embodiments, to operate during manufacturing operations as part of the quality control process. In addition, the built-in self-tester 160 is configured to be initiated via manual operation as well at the beginning of an analysis operation to ensure that the set of conductive tiles 146 are properly connected to the driving and/or sensing electronics. The built-in self-tester 160 can address manufacturing, assembly, transportation, and storage issues that can have dust in the components, oxidation issues, and/or physical misalignment.

In some embodiments, the built-in self-tester 160 of the cartridge is configured to operate independently without being connected to the instrument system 102. However, when connected to the instrument system 102, the built-in self-tester 160 can also verify the connection with the instrument system 102. In some embodiments, the instrument system 102 may initiate the self-test protocol on the built-in self-tester. In some embodiments, the built-in self-tester 160 is implemented in the instrument system 102. FIG. 1B shows an example of the system (shown as 100b) in which the built-in self-tester 160 is implemented in the instrument system 102 (shown as 102″). The self-testing circuit 160 may alternatively be disposed on a separate electronic board or disposed on the fluidic plate 142 within the cartridge 120.

Reagent/Test Assay. The cartridge can be preloaded with pre-defined assays to operate pre-defined tests in the field. Examples include nucleic acid extraction protocol, tissue sampling or culture growth, and metabolic rate monitoring. In some embodiments, the cartridge include ports to direct assay to specific test chambers to allow for customized operation and testing.

In some embodiments, the cartridge 120 is preloaded with appropriate reagents based on the target assay. The instrument system 102 can provide instructions or other control information to a user via the base user interface 108.

Once coupled together, the cartridge 120 can communicate with the instrument system 102 to also provide its identification type and/or specific control instructions for a given reagent set to be used in the electrowetting or digital microfluidics control operation for the intended or preloaded assay. For example, the cartridge 120 may have a pre-loaded sequence of instructions for a specific test such that the instrument system 102 can perform the required steps of the experiment.

The instrument system 102, including the instrument controller 108, can be configured to run experiments or perform functions in one of a set of selectable configurations, while the cartridge controller 124 may be configured to instruct the instrument system 102 on which configuration to run.

Cartridge Driving Circuitry. The driving circuits 128 are configured to actuate the set of conductive tiles 146 to move or mix fluid along the fluidic plate 142. For example, the driving circuits 128 may actuate the set of conductive tiles 146 such that fluid moves from the two or more reservoir, mixing, and/or testing regions 144 along the set of conductive tiles 146 such that the fluids combine. Then, the fluids can be moved to a sensing tile 152 where measurements can occur (e.g., measurement of target analytes). The signals from the sensing tile 152 or biosensors can be sent to and processed by the instrument system 102 (e.g., the base controller 104).

Example Cartridge Configuration

FIG. 2 illustrates an exploded view of an example cartridge 120 with details showing an example of the microfluidic electrode assembly 140 (shown as 140a) with the fluidic plate 142.

Housing. As shown in FIG. 2, the housing 122 includes a top portion 202 and a cartridge base 204. The top portion 202 is configured to sit on top of the cartridge 120 and surrounds a portion of the sides of the cartridge 120. The cartridge base 204 is disposed on the bottom of the cartridge 120. The cartridge base 204 has a pre-defined footprint geometry, e.g., having different size expanded corners to facilitate alignment and retention of the cartridge 120 to the instrument system 102. The microfluidic electrode assembly 140a is disposed between a portion of the housing 122 and the cartridge base 204. The electronics to operate the microfluidic electrode assembly 140a may be implemented in an adapter board 207 configured to mate, via connectors 206, to the microfluidic electrode assembly 140a.

Magnetic field Field Guide Focusing Assembly. In this example, the cartridge 120 includes a magnetic field focusing assembly. The cartridge base 204 includes an optional integrated magnet 208 that operates with an optional field guide 210. Also disposed between a portion of the housing 122 and the cartridge base 204 are an adapter board 207 and a field guide 210. The integrated magnet 208 and the field guide 210 represent one implementation of the cartridge 120 (see also FIG. 3C).

Adaptor Board. The adapter board 207 is disposed adjacent to and may be in electrical communication with the microfluidic electrode assembly 140a. The adapter board 207 may carry a variety of circuitry and electronics for the cartridge 120, for example, any one of the cartridge controllers 124, the cartridge interface 126, the driver circuitry 128, and the sensing circuitry 130 as described in relation to FIG. 1A.

The self-testing circuit 160 (e.g., built-in self-tester) may be disposed on the adapter board 207 or on the microfluidic electrode assembly 140a. The self-testing circuit 160 is configured to assess operative contact between the conductive-tile array 148 and the driving circuit 128. The self-testing circuit 160 is further configured to assess operative contact between the adapter board 207 and one or both of the conductive-tile array 148 of the fluidic plate 142 and the instrument system (e.g., 102).

Microfluidic electrode assembly. As shown in FIG. 2, the microfluidic electrode assembly 140a includes a fluidic plate 142 and a set of conductive tiles 146 disposed along the fluidic plate 142 that connect between two or more of the reservoir, mixing, and/or testing regions 144. The set of conductive tiles 146 (e.g., conductive pads) terminate at a set of corresponding conductive-tile array 148 located at an interface region 150 on the fluidic plate 142. The set of corresponding conductive-tile array 148 is coupled to the cartridge interface 126 and/or the adapter board 207 to facilitate communication between the microfluidic electrode assembly 140a and other elements of the cartridge 120. Other tiling configurations may be employed as generally understood in the art. Examples may be additionally found in the references included herein.

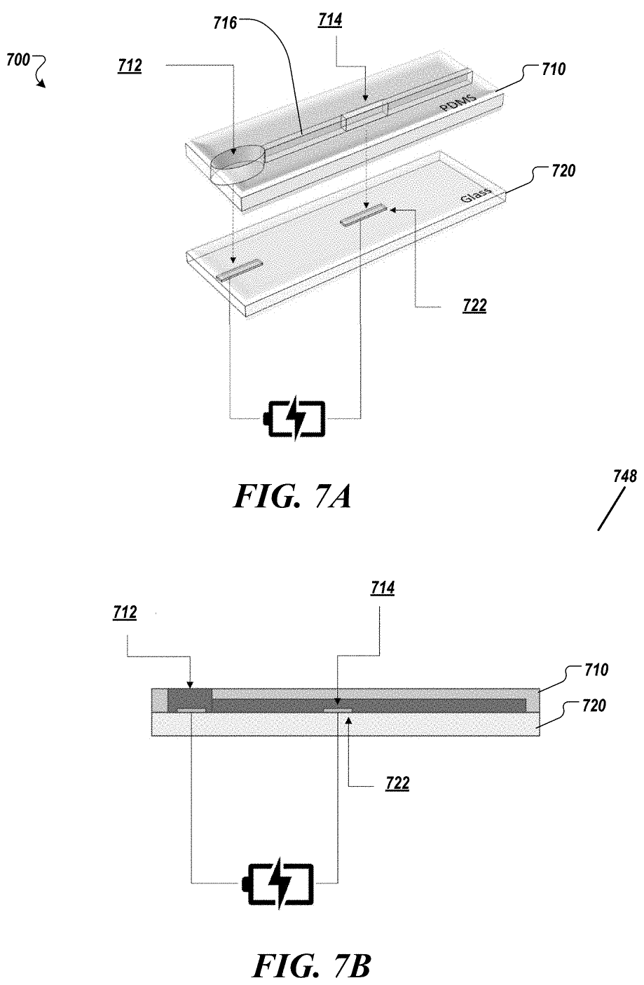

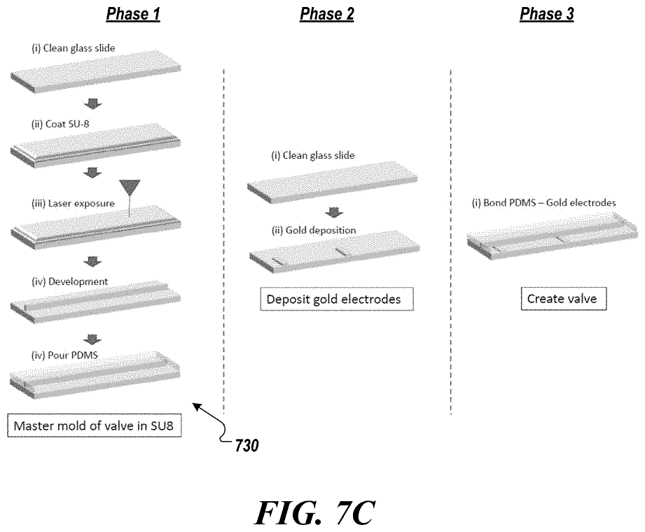

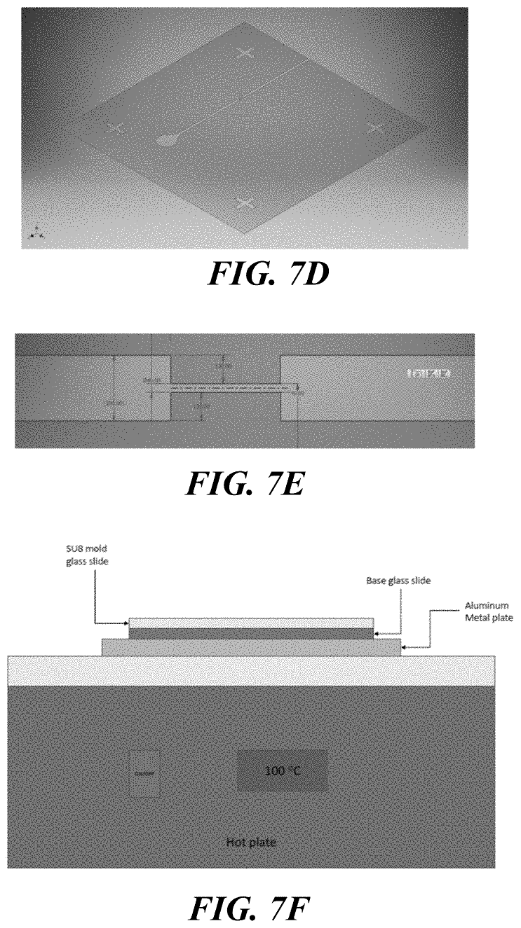

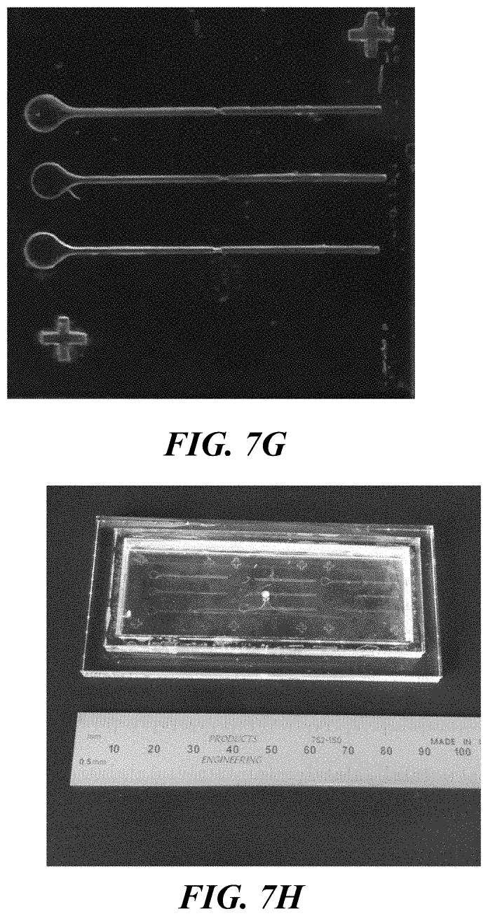

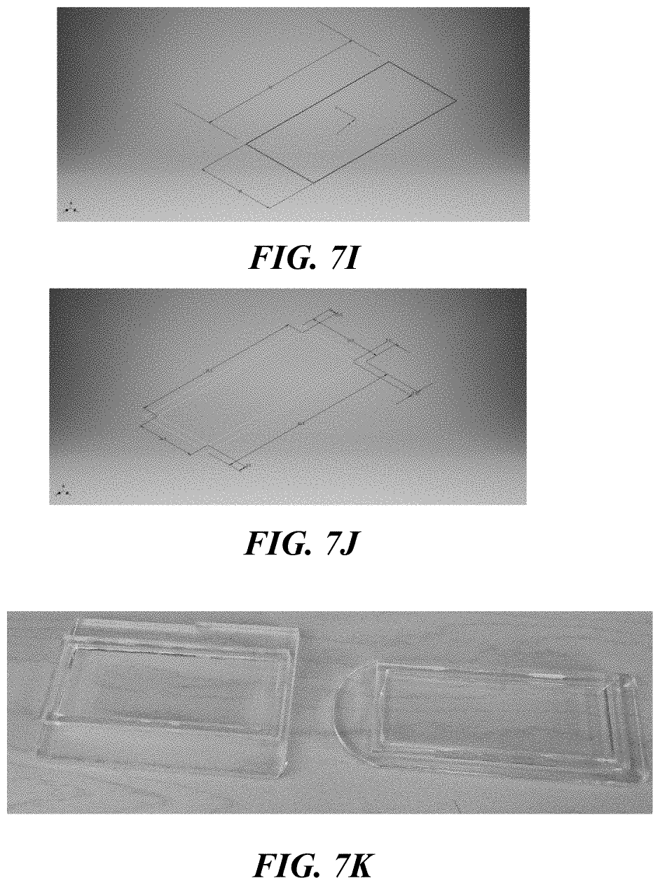

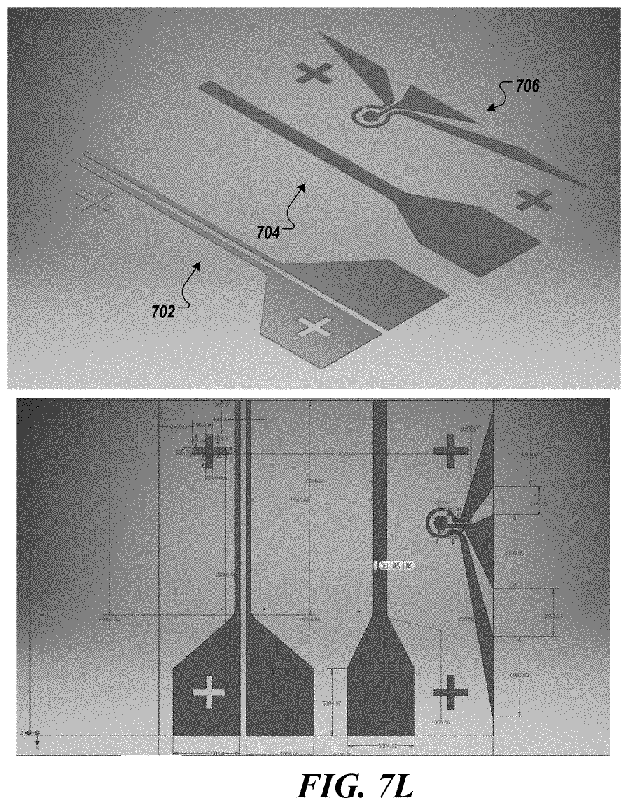

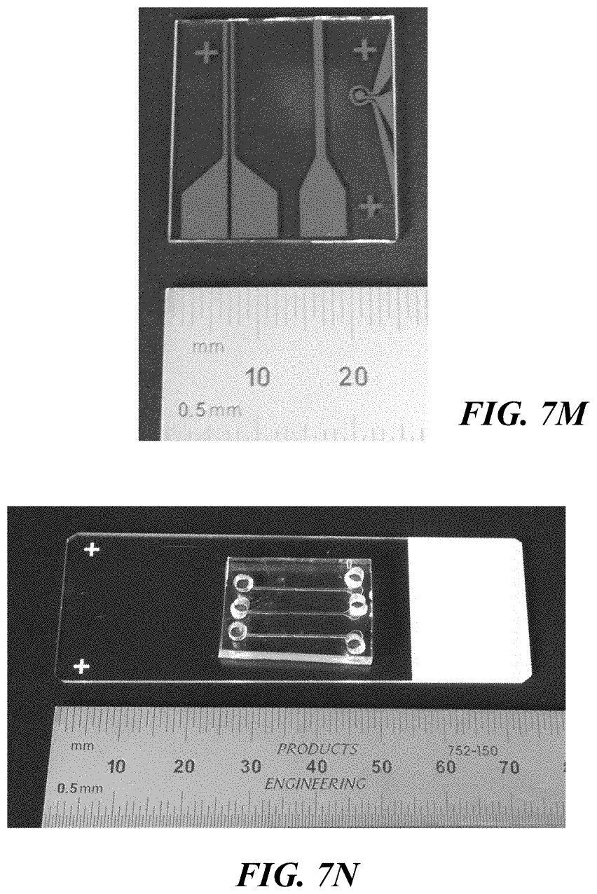

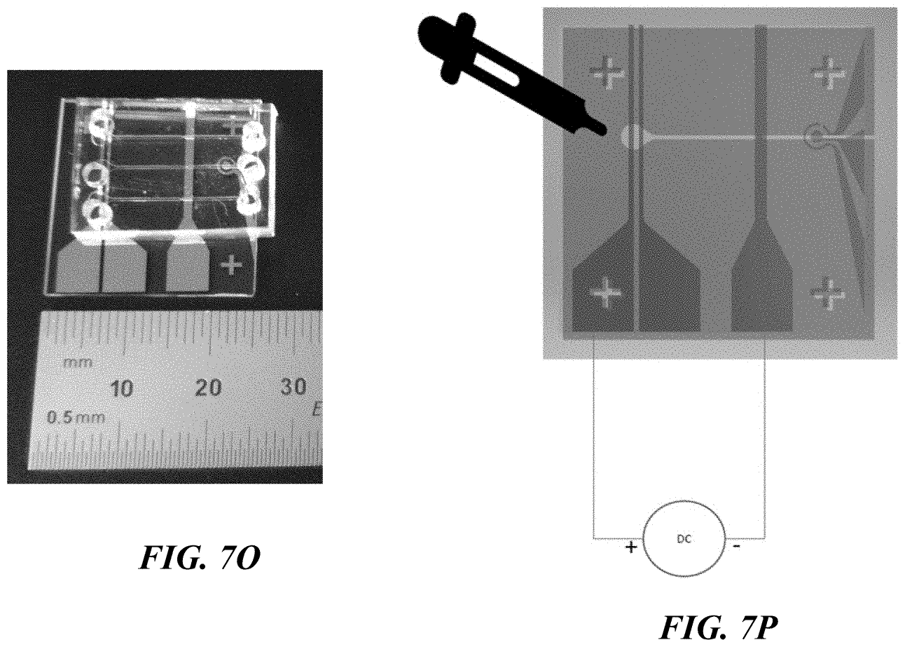

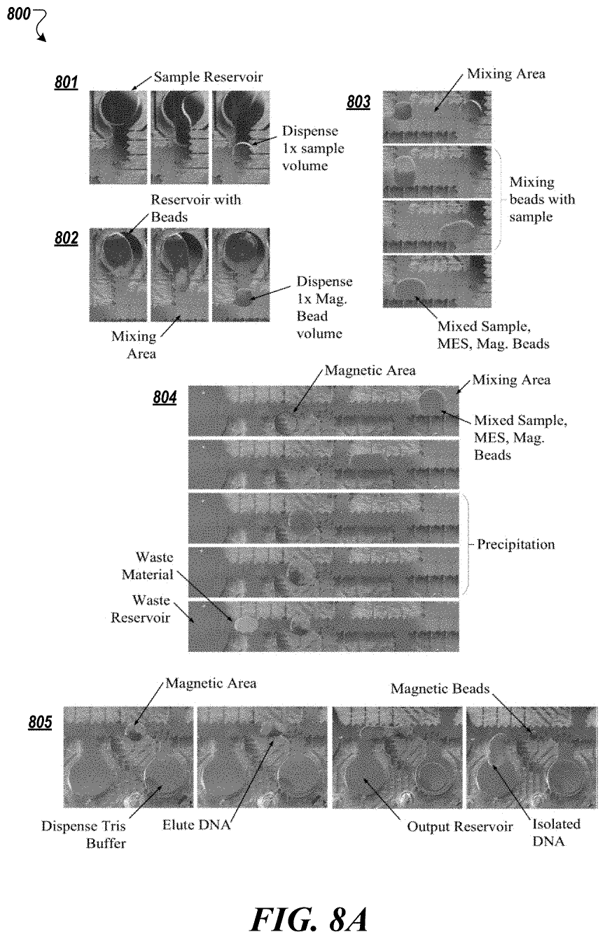

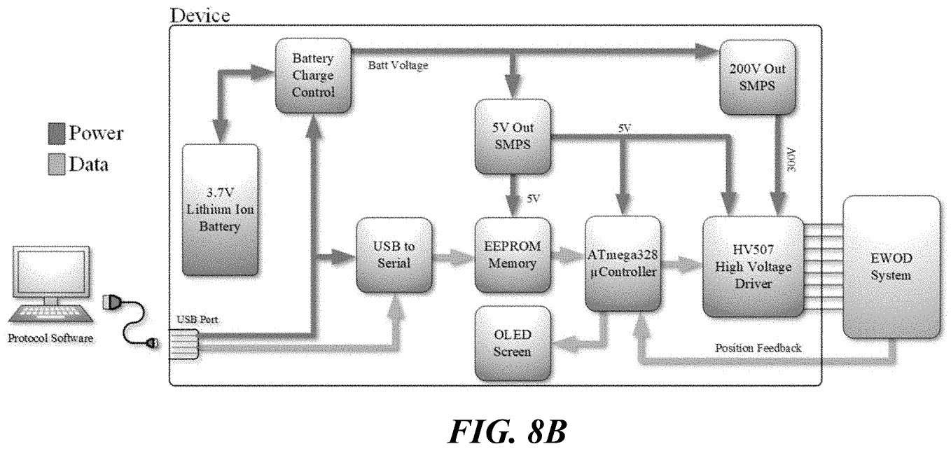

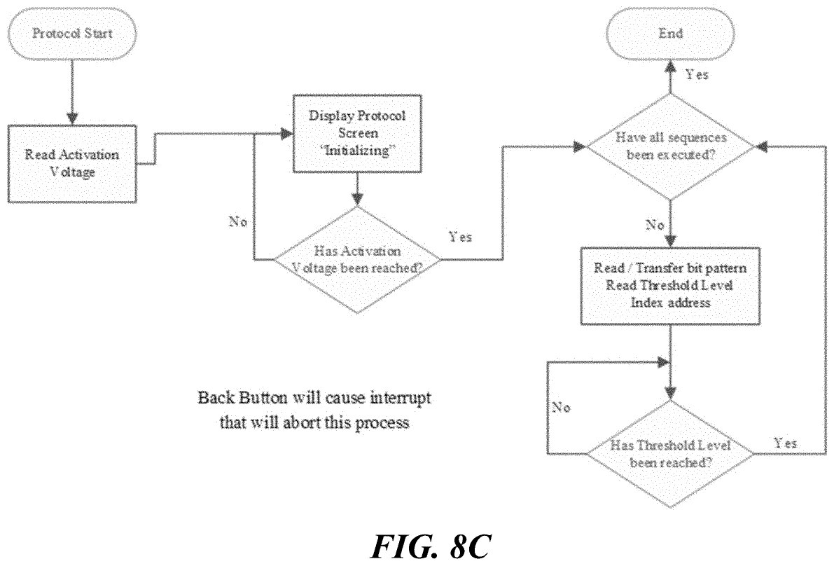

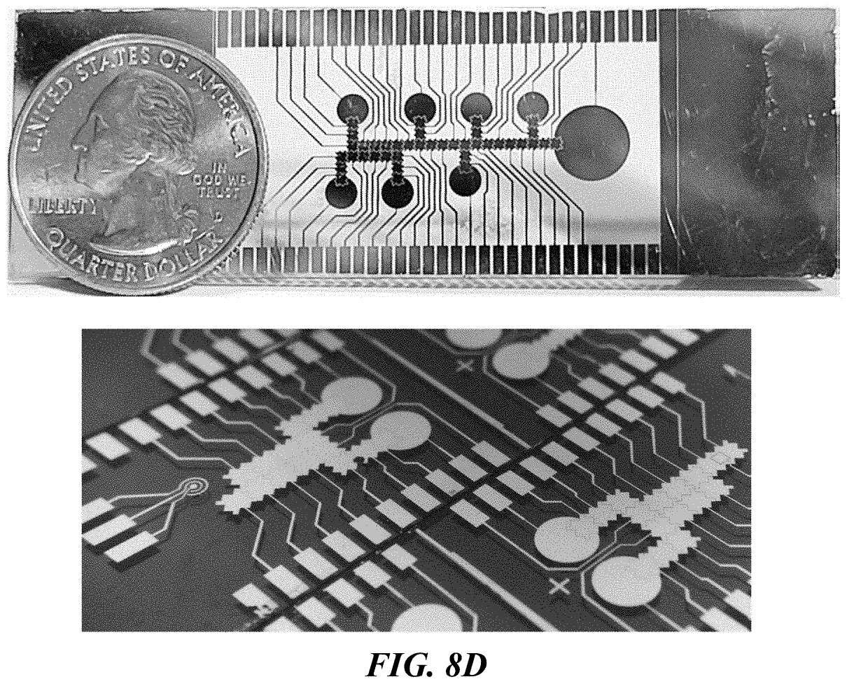

The fluidic plate 142 of FIG. 2 includes four reservoir, mixing, and/or testing regions 144. Regions 144a, 144b as reservoirs 144a and 144b, are disposed on one side of the fluidic plate 142 and may be configured to hold and dispense two fluids along the set of conductive tiles 146 by way of the driving circuits 128. Region 144c, as a mixing and/or testing region, is configured, for example, to capture the two-fluid mixture after the set of conductive tiles 146 moves the fluid along the fluidic plate 142. Region 144d is a sensor well, which may include a biosensor for testing or measuring specific properties of the two-fluid mixture. Regions 144c and 144d are connected, in this example, via a channel 212 coupled to an electronic valve 214. Generally, the electronic valve 214 is non-mechanical (e.g., a hydrophobic valve) and is configured to restrict a fluid flow across the valve 214 in a natural unactuated state. The valve 214 is configured to allow fluid flow across the valve 214 when actuated (e.g., wherein one of the first configuration or the second configuration comprises the application of an electric potential or current). Further description of the electronic valve 214 is provided in relation to FIGS. 7 and 8. To operate the valve and other components, the application of electric potential or current may be provided and controlled by the cartridge controller 120, the base controller 104, the adapter board 207, or a combination thereof, depending on the instructions and specific experiment to be performed. To this end, the entire microwatt application or digital microfluidic application can be performed entirely via electronic means and without external pneumatic or pressure sources, pumps, or mechanical actuation. These features can substantially reduce the cost of manufacturing the cartridge and instrument and improve overall reliability.

### Example Method of Operation #1

FIG. 3A illustrates a microfluidic chip 140 (shown as 300a) configured, e.g., as an electro-wetting on dielectric (EWOD) chip or digital microfluidic chip, having an electrode pattern design that can implement a nucleic acid extraction protocol among other operations described herein. The microfluidic chip 300a may be implemented in a cartridge (e.g., cartridge 120 of FIG. 1 or 2).

The microfluidic chip 300a includes a set of conductive tiles 146 (shown as 310), including transport pads 320 and reservoir pads 330 (which can be used as a reservoir storage or for mixing or testing as described herein). The microfluidic chip 300a also includes a set of contact pads 340 (e.g., within the array 154) on either side of the chip configured to contact and communicate with an adjacent circuit board (e.g., adapter board of a cartridge or a base system). Each transport pad 320 and reservoir pad 330 is in electrical communication with a corresponding contact pad 340 via an electrical trace 342. As noted above, the reservoir, testing, and mixing regions can be implemented flexibly and the various regions can be used for more than one purpose.

In the example shown in FIG. 3A, the microfluidic chip 300a includes forty-nine conductive tiles 310, including transport pads 320 and the reservoir pads 330. The reservoir pads 330 align with the reservoir wells configured to hold liquids for testing. For example, a sample reservoir 332 is disposed on one side of the microfluidic chip 330a. An output reservoir 336 and a waste reservoir 338 are disposed towards the opposite side the set of transport pads 320. For example, the output reservoir 336 is configured to capture a sample for analysis and measurement. In some implementations, output reservoir 336 includes a sensor or biosensor. Waste reservoir 338 can collect excess intermediate fluid or reagent fluid, separating it from a target fluid. A series of intermediate reservoirs 334 (e.g., reagent reservoirs) are disposed along the set of transport pads 320 between the output reservoir 336 and the sample reservoir 332.

The transport pads 320 are configured in this example to be 1 mm by 1 mm with a saw tooth edge design, and the transport pads are configured to move a volume of liquid along the microfluidic chip 300a. For example, a driving circuit (e.g., 128 of FIG. 1A) may apply a voltage or current to a transport pad 320 to motivate fluid from the sample reservoir 332 towards the output reservoir 336, or to motivate a reagent fluid from an intermediate reservoir 334 towards the output reservoir 336. In between the sample reservoir 332 and the output reservoir 336 is a mixing area 322 and a capture area 324. The mixing area is configured for mixing of a sample fluid (e.g., inserted into the sample reservoir 332 containing a preconfigured buffer solution) with a reagent fluid (e.g., housed in an integrated package assembly). The capture area 324 is configured for capturing a specific portion of the fluid mixture (e.g., keeping stationary a portion of fluid in the capture area 324 while moving a second portion of the fluid into the waste reservoir 338).

In use, a cartridge (e.g., 120) with the microfluidic chip 300a is coupled to a base instrument system. A testing circuit can assess the operative contact between the contact pads 340 and one or both of the cartridge and the base system. A set of instructions from one of a cartridge or a base system can cause the driver circuits to activate the conductive tiles 310, including the reservoir pads 330 and the transport pads 320. The activation can motivate or urge fluid from the reservoirs to a mixing area 232 to mix with one or more reagent fluids pre-loaded or also brought to the mixing area 322. The fluids can move along with transport pads 320 until the capture area 324 separates a portion of the fluid. A portion of fluid can enter the waste reservoir 338, while a different portion of fluid enters the output reservoir 336 for measurement and analysis.

The process used in example microfluidic chip 300a can match the process used for many nucleic acid extractions kits and accommodate a variety of different DNA extraction kits. The ratios in the microfluidic chip 300a (e.g., electro-wetting on dielectric chip) can match that of the effective ratios of traditional extraction kits, despite the smaller size and volume of sample and reagent. The microfluidic chip 300a (e.g., electro-wetting on dielectric chip) controls the quantity of fluid droplets moved, aided in part by the size of the transport pads 320 being uniform.

### Example Method of Operation #2

FIG. 3B illustrates a microfluidic chip 300b performing another DNA isolation procedure. In FIG. 3B, the sample reservoir 332 includes a sample volume of DNA, a first intermediate reservoir 334a includes a volume of MES buffer solution, a second intermediate reservoir 334b includes magnetic beads, and a third intermediate reservoir 334c includes tris buffer. The microfluidic chip 300b also includes a magnetic area 324 as the capture area (e.g., aligned with a magnet or magnetic field guide of a cartridge).

In use, the sample DNA and MES buffer are transported from their respective reservoir pads 330 along the transport pads 320 and into the mixing area 322. Magnetic beads are then moved into the mixed fluid at the appropriate ratio, and the mixed fluid is moved, provided, and/or inserted, into the magnetic area 324. The DNA-bound beads precipitate from the surrounding supernatant, and the supernatant containing any unbound DNA is moved to the waste reservoir 338 and discarded. Tris buffer can then be moved through the magnetic are 324 to elute the DNA from the beads while leaving the beads in the magnetic area 324. The eluted DNA can move into the output reservoir 336 for analysis.

Table 1 shows an example reagents for the two protocols of FIGS. 3A and 3B. Tables 2 and 3 provide examples for the two protocols: DNA isolation using immobilized filters and DNA isolation using magnetic beads, e.g., using the reagent set of Table 1.

TABLE 1

| Example Protocols | Reagent #1 | Reagent #2 | Reagent #3 |
|---|---|---|---|
| DNA Isolation with | PNI buffer (for | PE buffer (for | EB buffer (for |
| immobilized filters | purification) | clean & wash) | elution) |
| DNA Isolation with | MES buffer (for | Tris buffer (for | Magnetic |
| magnetic beads | bead binding) | elution) | beads solution |

TABLE 2
DNA Isolation with immobilized filter

| | |
|---|---|
| 1. | Place silicone oil into the cartridge using a pipette until all air is displaced. |
| 2. | A fluorescently tagged (optional) DNA with an initial concentration of 1 μg/μL is diluted |
| | 10:1 in DI water. |
| 3. | 2 μL of the diluted DNA solution is loaded into the sample reservoir. |
| 4. | Fill the first reagent reservoir with 2 μL of the PNI buffer (source: Qiagen). |
| 5. | Pre-dilute the PNI and PE buffers (source: Qiagen) with either ethanol or isopropanol per |
| | instruction. |
| 6. | Fill the second reagent reservoir with 2 μL of PE buffer (source: Qiagen). |
| 7. | Fill the third reagent reservoir with 2 μL EB buffer (source: Qiagen). |
| 8. | Pull one volume of the sample DNA and move it to the mixing area. |
| 9. | Pull 5 volumes of the PNI buffer and move it to the mixing area. |
| 10. | Mix the sample and the PNI buffer in the mixing area by activating the pads in a circular |
| | motion. |
| 11. | Move the final mixed solution to the DNA capture area for binding, one volume at a time. |
| 12. | Move the excess volume to the waste reservoir. |
| 13. | Move one volume of the PE buffer through the capture area and to the waste reservoir, as |
| | the washing step, until all of the PE buffer is removed from the reagent reservoir. |
| 14. | Move one volume of the EB buffer through the capture area, as the elution step, and |
| | deposit it in the output reservoir until the full volume of the EB reservoir is transferred to |
| | the output reservoir. |
| | (Optional) Open the electronically controlled valve to allow the extracted DNA in the output |
| | reservoir to flow to the sensor reservoir for detection. |

TABLE 3
DNA Isolation with magnetic beads:

This method uses the magnetic beads containing Chitosan to bind DNA given a slightly acidic
pH environment. DNA can then be released from the Chitosan by increasing the pH level of
the environment to a less acidic level. To control the pH levels and therefore binding and
eluting of DNA, MES buffer (pH 5.0) was used to bind DNA to the beads. Tris buffer (pH 8.8)
was used to elute the DNA from the beads.

| | |
|---|---|
| 1. | Place silicone oil into the cartridge using a pipette until all air is displaced. |
| 2. | Fill the sample reservoir with 1 μL of the DNA solution. |
| 3. | Fill the first reagent reservoir with 3 μL of magnetic bead solution. |
| 4. | Fill the second reagent reservoir with 8 μL of the MES buffer (pH 5.0). |
| 5. | Fill the third reagent reservoir with 4 μL of Tris buffer (pH 8.8). |
| 6. | Mix magnetic beads with DNA using a ratio of 3:1 of beads vs DNA in the mixing area of |
| | the cartridge. |
| 7. | Pull 2 volumes of the MES buffer and move it to a mixing area with each volume of the |
| | DNA solution until all the DNA and MES buffer solutions are mixed. |
| 8. | Mix the DNA sample and the MES buffer in the mixing area by activating the pads in a |
| | circular motion. |
| 9. | Move the final mixed solution to the DNA capture area where the magnetic field guide is |
| | to let the DNA bound beads precipitate from the surrounding supernatant. |
| 10. | Move the supernatant containing any unbound DNA to the waste reservoir. |
| 11. | Move one volume of the Tris buffer through the magnetic area and to the waste reservoir |
| | until all of Tris buffer is removed from the reagent reservoir. |
| 12. | Move the remaining solution in the magnetic area containing extracted DNA to the target |
| | reservoir. |
| 13. | (Optional) Open the electronically controlled valve to allow the extracted DNA in the |
| | output reservoir to flow to the sensor reservoir for detection. |

Electro-Wett Operation with Impedance-Based Feedback

FIG. 3C illustrates an example circuitry for an electro-wetting on a dielectric system (e.g., the microfluidic chip 300 of FIG. 3A or 3B). FIG. 3C shows an impedance-based feedback detection circuit 360 and its implementation into an example microfluidic chip 340. The example microfluidic chip 340 (e.g., an electro-wetting on the dielectric system) includes a substrate 342, a conductive layer 344, a hydrophobic layer 346, an insulating layer 348, and a droplet 350.

To make a droplet of fluid move reliably, an impedance-based feedback detection circuit 360 can be implemented to monitor the intended droplet movement. An electro-wetting on a dielectric system inherently produces a different impedance based on the presence of the droplet over an active pad (e.g., a transport pad 320 of FIGS. 3A and 3B). The example microfluidic chip 340 forms a voltage division circuit between the activated pad and Rₜᵤₙₑ. When the droplet 350 has not reached the active pad, a high impedance path is formed through the capacitive nature of the media (C_{media}). The relatively high impedance of C_{media} causes a large voltage drop across C_{media} and Cᵢₙₛ, forcing V_{FB} to be low (effectively ground).

As the droplet 350 reaches the active pad, it displaces the media, removing C_{media} and inserting a low resistive path formed by the conductive droplet (R_{drop}). The low resistance of the droplet 350 causes a larger voltage drop across Rₜᵤₙₑ. Because the capacitance of C_{media} is dependent on the geometry of the EWOD chip (pad size, ground plane height, etc.) Rₜᵤₙₑ is selected to produce a max voltage that is within the range of the sensing Analog to Digital Converter (ADC) of the system. The signal seen at V_{FB} is an attenuated version of the activation signal with a 0 V direct current (DC) offset due to the insulating layer of the EWOD chip (Cᵢₙₛ) forming a high pass filter. Therefore, V_{FB} is sent through a half wave rectifier and low pass filter to create a DV voltage (Vₛₑₙₛₑ) that is proportional to the droplet (350) position.

The controller (e.g., 124), e.g., a microcontroller can monitor Vₛₑₙₛₑ to determine if the droplet 350 has reached the intended destination and is able to progress to the next sequence in the protocol. The feedback system can detect whether a droplet 350 fails to move on to the active pad. If so, the applied voltage for the movement is adjusted, and the movement is tried again until the droplet 350 moves onto the active pad or the maximum number of trials have been reached. Common situations for a droplet 350 failing to be moved onto an active pad include dirt particles in the EWOD system, manufacturing variations resulting in surface imperfections, and dielectric breakdown during operation.

FIG. 3D illustrates the progression of fluid along the microfluidic chip (e.g., the microfluidic chips of FIGS. 1A, 1B, 2, 3A-3C) alongside experimental data gathered from testing the impedance-based feedback detection circuit 360 of FIG. 3C. The capability of the feedback circuit was demonstrated by recording the values of Vₛₑₙₛₑ while moving a droplet in a loop over a select group of pads. FIG. 3D shows the recorded values of Vₛₑₙₛₑ over time by the analog-to-digital converter of the microcontroller as a droplet was cycled around the loop manually four times. The location of each pad shown in FIG. 3D is shaded in the corresponding diagram below each captured Vₛₑₙₛₑ waveform. Most of the pads show ideal results where the magnitude of Vₛₑₙₛₑ asymptotes to the desired value as the droplet moves over the active pad. Additionally, on each pass of the loop, the same threshold voltage is reached. Pad 24 highlights possible damage to the pad resulting in a slightly higher voltage seen on Vₛₑₙₛₑ. Since most of the voltage drop from the active pad is over the droplet and dielectric layer, any damage caused by breakdown lowers the resistance, which raises the voltage over Rₜᵤₙₑ. Some pads, such as 41, show a slower rise to their max voltage during the early cycles, and droplet movement becomes faster with every additional cycle. This implies that the droplet is becoming easier to move with each use. Longer movement time is a result of higher resistive forces on that pad, possibly due to surface imperfections. Pads 25 and 37 have slightly higher max voltages which could also be caused by manufacturing variations. Overall, these results provide insight into the many variations the system must face. This information was then used to create an adaptive algorithm in firmware to help reliably move droplets.

Example Integrated Magnet with Fieldguide

As discussed above in relation to FIG. 2, the cartridge 120 may be implemented with a magnetic field-focusing assembly. The cartridge base 204 can include an integrated magnet 208 that operates with a field guide 210. Also disposed between a portion of the housing 122 and the cartridge base 204 are an adapter board 207 and a field guide 210.

Some assays, such as DNA isolation, include the use of magnetic beads. Magnet 472 (e.g., a traditional magnet, electromagnetic coil, or programmable coil array) creates a magnetic field used to keep the beads stationary during a portion of the assay. Due to the small size of the microfluidic electrode assembly 400b, 400c, the magnetic field can affect the beads throughout the chip, causing unwanted movement. The magnetic field guide 470 redirects stray magnetic fields and leaves a focused field in a desired location 474.

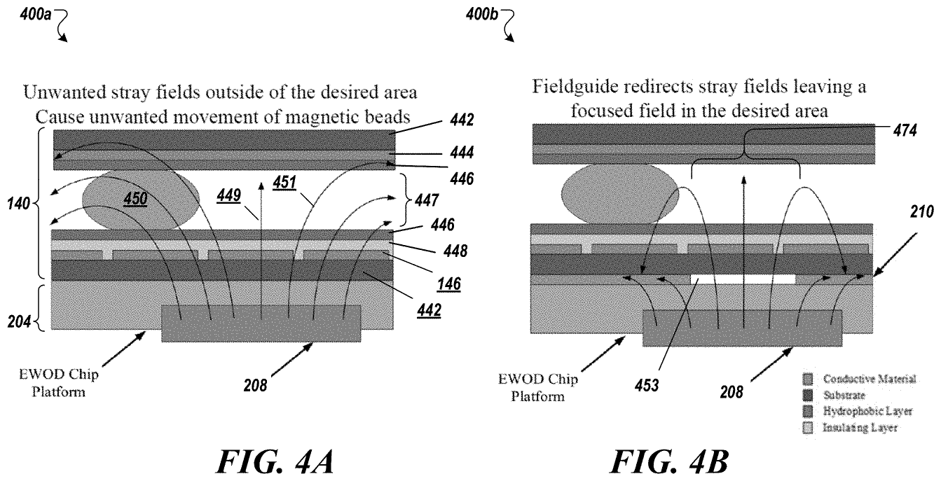

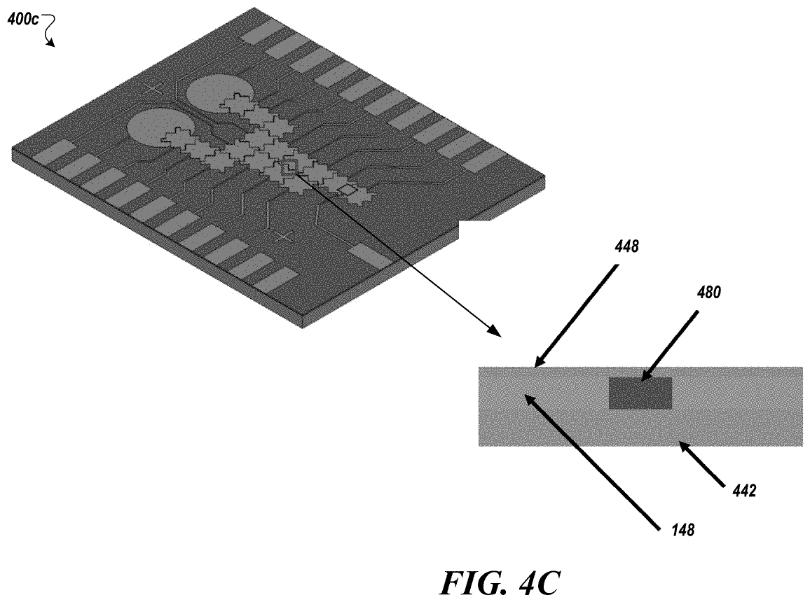

FIGS. 4A and 4B, respectively, shows a cross-sectional operation of a microfluidic electrode assembly (e.g., EWOD chip within a cartridge) with and without the magnetic field focusing assembly. The microfluidic electrode assemblies 140 (shown as 400a and 400b) include a set of conductive-tile array 146 that operates with a ground plane 444 to direct a droplet 450 through a channel 447. The microfluid electrode assembly (e.g., 140, 400a, 400b) includes a conductive-tile array 146 formed of a conductive material that is embedded within an insulating layer 448. Hydrophobic layers 446 are formed (i) over the conductive-tile array 146 and insulating layer 448 and (ii) over the ground plane 444 to form the interior surface for the channel 447. The ground plane 444 and the conductive-tile array 146 are formed on a glass substrate 442.

The microfluid electrode assembly (e.g., 140, 400a, 400b) can be formed over a cartridge base 204, e.g., formed of a plastic (e.g., thermoplastic). The cartridge base 204 includes a magnet 208 that generates a magnetic field (shown by field lines 449 and stray field lines 451) over the conductive-tile array 146. The magnets provide a static field 449, 451 over the conductive-tile array 146 that can then generate dynamic fields to urge movement or retention of the droplet at desired locations in the channels of the microfluidic electrode assembly. The magnets reduce the operational electrical requirements of the conductive-tile array 146 and the associated driving circuitries. While a permanent magnet 208 is shown in the example of FIGS. 2, 3A, and 3B, other magnetic generating components may be used, including electromagnets circuits via an electromagnetic coil, e.g., in a programmable coil array.

As shown in microfluidic electrode assemblies 400a, the stray magnetic fields (shown by lines 451) are outside of the desired area and are known to cause unwanted movement or unwanted loss.

In microfluidic electrode assemblies 400b, by focusing the magnetic field with a magnetic field guide 470, the stray magnetic fields can be redirected into a narrower beam to provide a focused field for a desired location 474. As shown in FIG. 2, the field guide 210 can include an aperture 453 formed at desired locations for the magnetic field focusing. The field guide 210 may be formed of a dielectric material that can shape the magnetic field profile.

Conductive-Tile Array with Dielectric In-Fill

FIG. 4C illustrates another feature of the conductive-tile array 146 to improve the electrowetting operation using a dielectric infill. In the example of FIG. 4C, the cross-section view of a microfluidic chip 400c is shown having two nearby conductive-tiles 146 of the array. The tiles are patterned and have a gap between them.

Existing manufacturing techniques for digital microfluidic devices can leave the airgap between the electrode pads. It is observed that when coating the surface the dielectric materials, this can airgap presents a reliability problem for devices operating at high voltage when moving droplets.

In FIG. 4C, the microfluidic chip 400c is constructed by pre-filling the airgap with a low-dielectric strength material to planarize the overall surface. The in-fill dielectric can advantageously remove the dielectric weak point in a straightforward manner and without requiring an expensive manufacturing process. The in-fill dielectric can also advantageously provides a smooth surface for electrowetting. The in-fill dielectric can also advantageously allow for lower-cost substrates like PCBs to be used.

As shown in FIG. 4C, the microfluidic chip 400c includes electrode pads 146 that is formed over PCB substrate 442 and are filled with a low dielectric strength fill material 480 disposed between the electrode pads 146. A high dielectric strength material is then disposed on top of the low dielectric strength fill material, and the electrode pads 146 as the insulating layer 448.

Example Electronic Circuitry

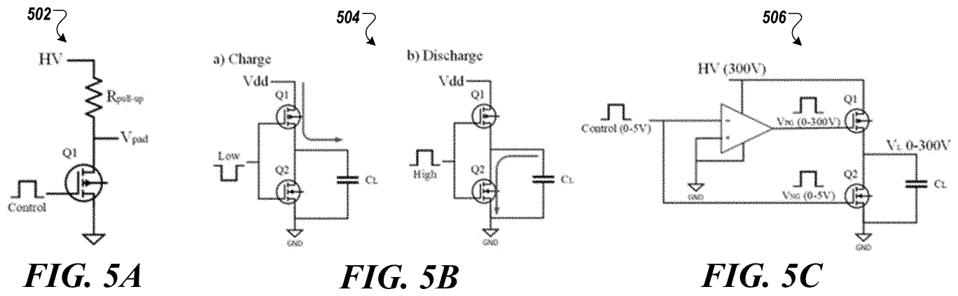

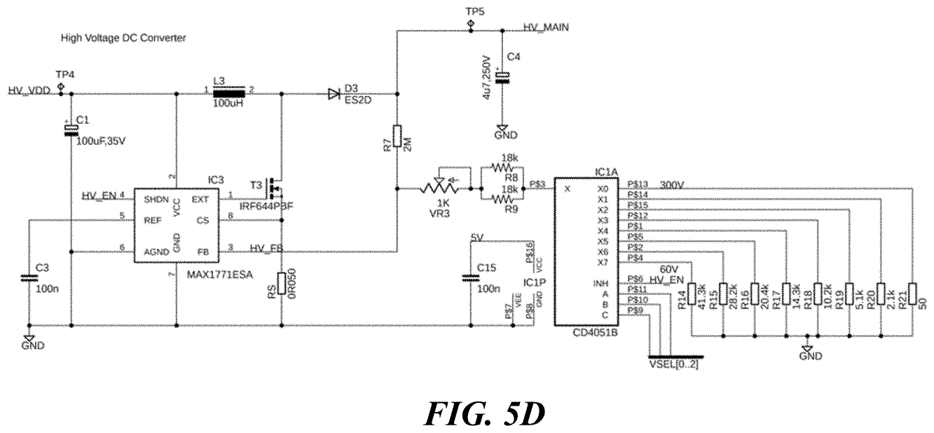

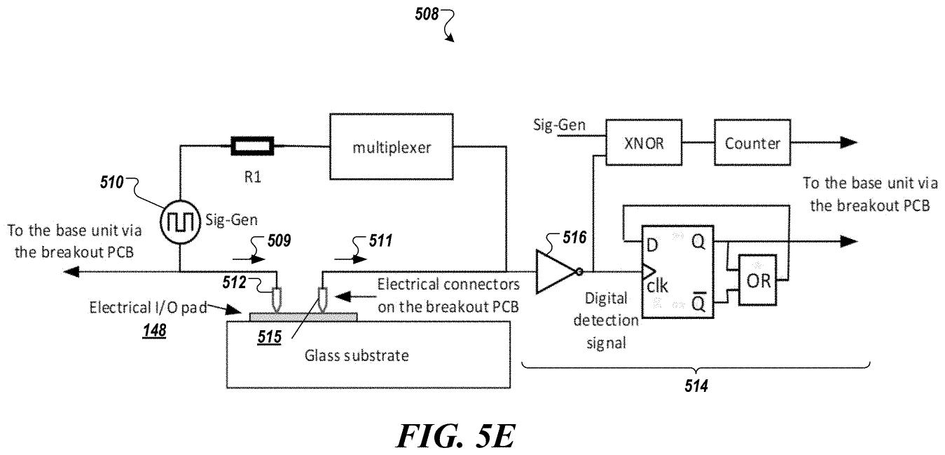

FIGS. 5A-5E illustrate example circuitry for driving the systems and devices of the cartridges and microfluidic electrode assemblies herein described. FIG. 5E shows the BIST circuitry.

Driver Circuit. FIGS. 5A and 5B each shows an example driver circuit configured to charge the conductive-tile array 14. Specifically, FIG. 5A shows a high-voltage driver circuit 128 (shown as 502) that can be implemented to actuate each individual tile of the conductive-tile array 146. The high-voltage driver 502 is implemented using a MOSFET switch through a pull-up resistor. FIG. 5B illustrates a CMOS version (504) of the high voltage driver (502) for charging and discharging the electrode pad (e.g., the set of conductive tiles of the microfluidic electrode assembly of FIG. 1A). The high voltage driver 504 includes a first switch (shown in the example as a MOSFET) to charge the pad and a second switch (also shown as a MOSFET) that can discharge the same pad. The high voltage driver circuit of FIG. 5A, or the CMOS version of FIG. 5B, may be implemented in an example cartridge (e.g., in a driver circuitry of cartridge 120 in FIG. 1A).

FIG. 5C illustrates another configuration of the driver circuit 128 (shown as 506). The driver circuit 506 of FIG. 5C includes a level shifter configured to generate a high voltage to drive the electrode pads. The level shifter is configured to operate with a low-voltage control input signal.

FIG. 5D illustrates a high-voltage DC-DC boost converter circuit used in the system (e.g., in the cartridge 120 in FIG. 1) to provide the high-voltage source for the circuits of FIGS. 5A-5C.

Built-in Self-Test Circuit. FIG. 5E shows an example BIST circuit 508 for the BIST feature. The BIST circuit 508 includes a signal generator 510 that is configured to provide a driving test signal 509 to the first termination point 512 on an electrical I/O pad (e.g., 148). The driving test signal 509 is also provided the controller 104 of the base unit 102. The BIST circuit 508 includes a detection circuit 514 that receives a corresponding test signal 511 of the driving test signal 509 from a second terminal 515, e.g., located in connector 206 of the adapter board 207. The detection circuit 514 includes a buffer 516 and a latched comparator/counter that determines if a corresponding test signal 511 is sensed for each of the driving test signal 509. The detection circuit 514 counts a driving signal 509 and clears the driving signal when a testing signal 511 is received. When there is a mismatch, the detection circuit 514 outputs an error signal that is then provided to the BIST controller 160 and/or the instrument controller 104.

Example Reagent Storage and Packaging

The cartridge (e.g., 120) may be configured with a passive reagent storage and packaging that maintains the pre-loaded reagents in an isolated inert chamber or location that is not in contact with the testing circuitries or microfluidic circuits. Prolonged contact, and even exposure, of the reagents to the electronic or fluidic circuit while in storage can degrade the operation and/or performance of the cartridge after a period of storage. To reduce the number of active components and thus the cost of the cartridge, the pre-loaded reagents may be maintained in the chamber that is isolated from the electronic or fluidic circuit by a buffer solution (e.g., a silicon oil).

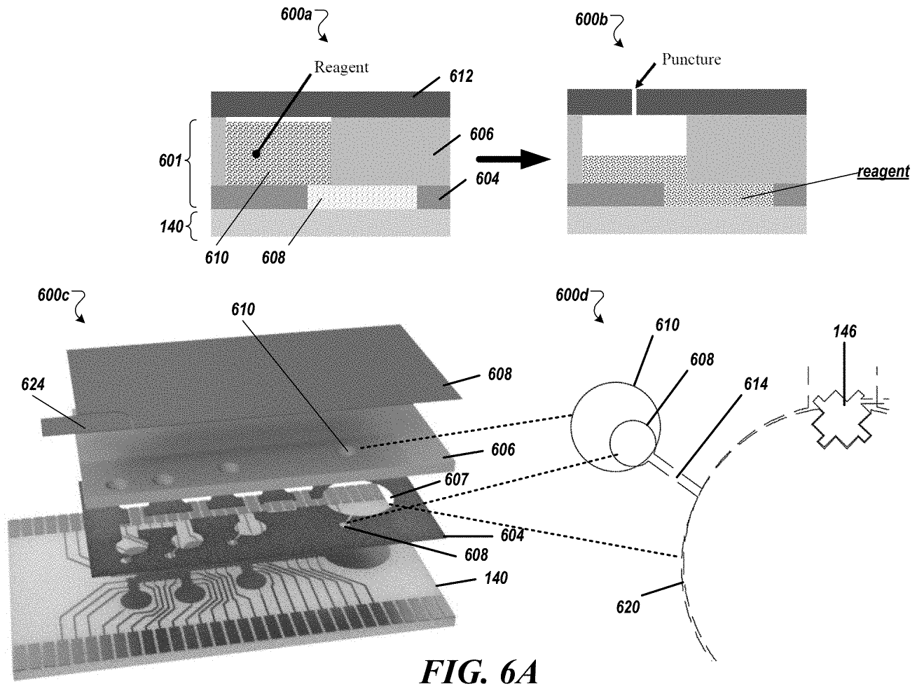

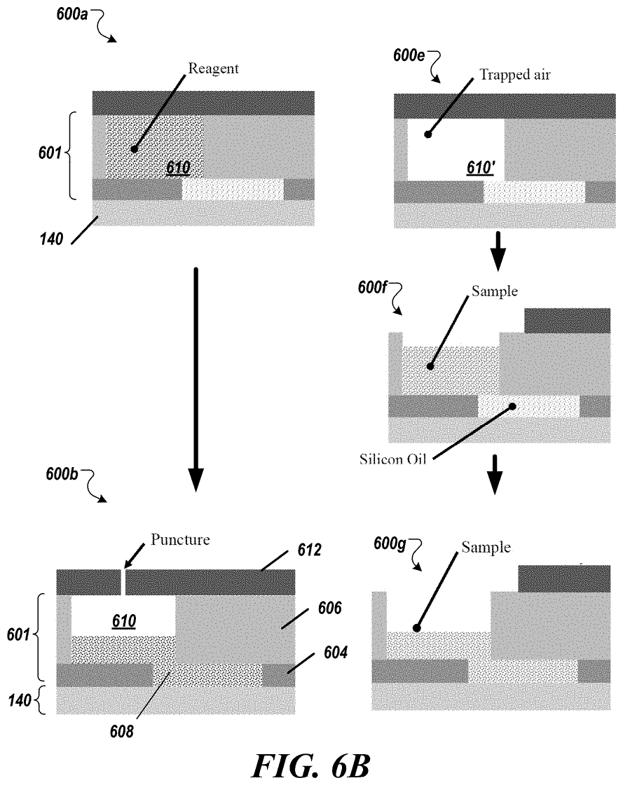

FIG. 6A shows an example configuration and operation of the passive reagent storage and packaging. In FIG. 6A, the microfluidic assembly 140 (shown as 140b) is shown with a packaging isolation structure 601 having two intermediate storage layers 604, 606 that form chambers 608, 610 therein. A cover seal 612 is attached over the packaging isolation structure 601. The cover seal 612 keeps the fluids stable by maintaining the interior pressure.

The first layer 604 of the packaging isolation structure 601, as a buffer layer, is in direct contact with the microfluidic assembly (e.g., 140b) and includes a buffer solution or oil in a buffering chamber 608 formed in the layer. The second layer 606 of the packaging isolation structure 601, as a reagent storage layer, is in direct contact with the first layer (e.g., 140b) and includes the regent storage chamber 610 that houses the pre-loaded reagents or various solutions to be employed in the analysis of the cartridge. The buffer solution or oil is a low-density fluid and has a density that is lower than that of the reagents or various solutions. With the cover seal 612 placed over in sealed contact with the packaging isolation structure 601, as shown in diagram 600a, a vacuum or lower pressure is formed within reagent storage chamber 610 of the reagent storage layer 606. With the cover seal 612 being removed or punctured, as shown in diagram 600b, the vacuum or lower pressure environment is thus removed as the interior structures are open to the atmosphere, and hydrostatic pressure dynamics between the buffer solution or oil in the chamber 608 and the reagent storage chamber 610 are initiated in which the low/lower density buffer solution or oil in the buffer chamber 608 is allowed to flow from the buffer chamber 608 to the reagent storage chamber 610 while the pre-loaded reagent or solution of each reagent storage chamber 610 is allowed to flow into the buffer chamber 608 that is contact with the microfluidic assembly (e.g., 140b). To this end, as shown in diagram 600b, the reagent is in contact with a portion of the microfluidic assembly (e.g., 140b) and is now ready for electrowetting operation as described herein.

Diagram 600c shows an example configuration of the cartridge having the two intermediate storage layers 604, 606, that form chambers 608, 610. Diagram 600d shows an above-view overlap between the different structures of the layers. As shown in diagrams 600c and 600d, the reagent storage chamber 610 is seated above the buffer chamber 608. The buffer chamber 608 is connected over a channel 614 to analyte/reagent holding chamber 620 (e.g., reservoir 144c) that overlaps with the tiles of the conductive-tile array 146. The buffer chamber 608, and maybe the channel 614, is pre-loaded with the silicon oil 622 to fluidically isolate the content of each reagent tank 610 from other areas of the microfluidic chip 600. The isolation also reduces risk of premature mixing or fluid flow before the desired operation.

FIG. 6B shows additional operations using the passive storage structure. In FIG. 6B, diagram 600a shows the passive storage structure 601 filled with a reagent, buffer, or analyte in reagent storage chamber 610. Diagram 600b shows the vacuum or lower pressure environment being removed as the interior structures are open to the atmosphere, and hydrostatic pressure dynamics between the buffer solution or oil in the chamber 608 and the reagent storage chamber 610 being initiated in which the low/lower density buffer solution or oil in the buffer chamber 608 is allowed to flow from the buffer chamber 608 to the reagent storage chamber 610 while the pre-loaded reagent or solution of each reagent storage chamber 610 is allowed to flow into the buffer chamber 608 that is contact with the microfluidic assembly (e.g., 140b).

Similar operations can be performed for the sample. Diagram 600e shows the passive storage structure 601 being filled with trapped air or inert gas in a corresponding structure to the reagent storage chamber 610 (shown as chamber 610′). As shown in diagram 600f, the seal cover is removed during operation and the sample can be placed in the chamber 610′, which, as shown in diagram 600g, the sample is allowed to flow into the reservoir 608.

Referring to FIG. 6A, the microfluidic electrode assembly (e.g., 140b) includes an electrode array (e.g., a set of conductive tiles disposed on a fluidic plate) disposed on a glass chip configured with all the dielectric coatings and structures designed for a given assay. The first layer 604, as the buffer layer, of the packaging isolation structure 601 is a thin layer of dielectric material forming a set of channels to guide droplets movement and manipulations.

The second layer 606, as a reagent storage layer, of the packaging isolation structure 601 provides the reagent tank layer where specific reagents are stored for a given assay. While not shown, the round plane layer can be fabricated between the first and second layers 604, 606. The cover seal 612 is a cover layer that seals the reagent in the reagent tanks. When pulled open, it allows reagents to flow to the desired reservoirs for intended applications. In FIG. 6A, the pull tab 624 can be used to activate the cartridge (e.g., 120).

Example Hydrophobic Valve Function and Method of Construction

As discussed above, reservoirs (e.g., 144c and 144d) may be connected to other structures in the microfluidic device via an electronic valve 214. The electronic valve 214 is non-mechanical (e.g., a hydrophobic valve) and is configured to restrict a fluid flow across the valve 214 in a natural un-actuated state. The valve 214 is configured to allow fluid flow across the valve 214 when actuated (e.g., wherein one of the first configuration or the second configuration comprises the application of an electric potential or current).

For actuation, the electronic valve 214 may be a hydrophobicity effect-based micro-valves that use the principle of capillary action and direct electrowetting. Capillary action causes movement until the fluid reaches the valve area. The bottom of the valve area can be made of metal or a self-assembled monolayer (SAM). In the valve region, movement through it can be controlled by electrowetting of the bottom electrode area. Fluid can then move in a microchannel due to the hydrophilic nature of the glass-bottom till it stops at the hydrophobic valve area made of the gold electrode. The flow can start again after the application of a potential between fluid and metal electrode. The valve width can be configured to be adjusted to stop the fluid. The flow velocity depends on the geometry and wettability of the flow channels. It is defined by the Washburn equation, as Equation 1 below:

$$\begin{matrix}Equation 1 : & \\ v = \frac{γ LV}{8 η x} {( \frac{h ω}{h + ω} )}^{2} [ \frac{2 cos {θ}_{PDMS}}{ω} + \frac{cos {θ}_{PDMS} + cos {θ}_{Glass}}{h} ] & ( Eq . 1 )\end{matrix}$$

In Equation 1, v=average flow velocity, h=height of the flow channel, w=width of the flow channe η=viscosity of the solution, x=distance between the inlet of the flow channel to the meniscus of the moving liquid column, γLV=interfacial tension between the solution and the capillary wall, θ_{PDMS}=contact angles on PDMS, θ_{Glass}=contact angles on glass.

Based on Equation 1, the geometry of the experimental valve can be designed. In a study, experiments were conducted for nine models of valves with widths of 80 micrometers, 100 micrometers, and 120 micrometers with three heights of 40 micrometers, 60 micrometer, and 80 micrometer. The width of the microchannel was kept constant at 300 micrometers for all. However, in other implementations, various other geometries are available.

Construction of Hydrophobicity-Effect-Based Micro-Valve. FIG. 7A depicts an example system 700 with a hydrophobic valve using direct electrowetting of metal (Gold), including the construction process for the hydrophobic valve. The system 710 includes two substrates proximal to each other—Polydimethylsiloxane (PDMS) slab 710 and the glass substrate 720 that can form a microfluidic electrode assembly (e.g., 140, 140a, 140b, 300a, etc.). The PDMS slab 710 includes a reservoir 712 and the hydrophobic valve 714, the reservoir 712 and valve 714 being in fluid communication with each other via a microchannel 716. The glass substrate 720 includes a gold electrode 722 disposed adjacent to each of the reservoir 712 and the valve 714.

The glass of the glass substrate 720 at the bottom of microchannel 716 connecting microvalve 714 is hydrophilic. Gold electrodes 722 are hydrophilic immediately after cleaning, but on exposure to air, a hydrophobic monolayer of carbonaceous contamination is formed on the surface. This layer is used as a valve. The contact angle on the gold is changed by performing a plasma treatment. The PDMS is hydrophobic with a contact angle 110°. No change in contact angle is done for PDMS. If PDMS is treated, then valve action is not seen, and fluid flows from one end to another with a minimal plasma treatment duration.

Construction of Hydrophobicity-Based Microvalve.

FIGS. 7A and 7B also show a process to construct a microvalve 714 and system 700. The microvalve 714 can be made by pouring PDMS on a master mold 730 of the microvalve. The master mold 730 is then created using SU-8 2050, a permanent epoxy negative photoresist. SU-8 has been used to construct MEMS for years and is capable of producing near vertical, high aspect ratio structures. Gold electrodes 722 can be made using a vapor deposition process on glass 710. Both of these (gold and glass) can then be bonded to each other by an oxygen plasma treatment on glass 710 with electrodes 722. PDMS is not treated with plasma to keep it hydrophobic. The hydrophobicity of gold can be changed by performing the oxygen plasma treatment.

FIG. 7C shows steps to create a hydrophobicity-based valve 714. Two types of molds are shown, including a microvalve SU8 mold and a microvalve acrylic mold.

Phase 1 of Model Fabrication—Microvalve SU8 Mold. FIGS. 7D-7F show an example microvalve SU8 mold. Specifically, FIGS. 7D and 7E show the mold design for the SU8 mold. In one experimental example, the materials used for the Microvalve SU8 Mold include: Glass slide for mold (AmScope, size 25.4×76.2×1 mm), Glass slide as a base plate (AmScope, size 25.4×76.2×1 mm), Aluminum Metal plate (Homemade, size 64×90×4 mm), SU-8 (MicroChem Corp., MA, USA), SU-8 developer (MicroChem Corp., MA, USA), Acetone (KMG, TX, USA), Isopropanol (KMG, TX, USA), DI water. In the same experimental example, the equipment used includes: Hot plate (Opersder 946C), Laser writer (LW405C, Microtech srl, Italy), Rocker platform (Bellco biotechnology, NJ, USA), Magnetic stirrer (Corning, NY, USA) Spin coater (Nilo 4, Ni-Lo Scientific, Ottawa, Canada).

FIGS. 7D and 7E show the design of the mold created using computer-aided design (CAD) software to generate files readable by the laser writer. A narrow neck region is shown, connected to wider microchannels. Following the design, the mold was used to create the microvalve using processes set out in Table 4. FIG. 7F shows the setup for the SU8 valve mold and the process for construction.

Table 4 shows an example process to generate the microvalve SU8 model.

TABLE 4

| | Step | Example Embodiment |
|---|---|---|
| 0 | Pre-Step | A metal plate (e.g., aluminum) is placed on a hot plate. Then, a clean |
| | | glass slide is placed on the metal plate. A glass slide, from which the |
| | | mold will be created, is placed on the |
| 1 | Prepare SU8 | 1. Wash glass slide using a hand soap under running tap water to |
| | base coat | remove any organic residues 2. Dry glass slide using Nitrogen jet; 3. |
| | | Put it in acetone bath and stir using the magnetic stirrer or by rocking |
| | | motion on the rocker platform for 10 minutes; 4. Rinse using |
| | | Acetone, IPA and DI water; 5. Remove stains/dirt using kimwipes |
| | | and acetone; 6. Evaporate all liquids on the slide by putting it on the |
| | | hotplate for 10 min @ 65° C. (Keep it on another clean glass slide); 7. |
| | | Cool the slide by taking it off the metal plate for 10 min and placing |
| | | on a metal plate; 8. Nitrogen dry again to remove any remnants; 9. |
| | | Heat the glass slide for 65° C. 10 min; 10. Switch off the hot plate; 11. |
| | | Pour SU8 preferably direct from its bottle on prepared glass slide; 12. |
| | | Spread SU using a wooden mixing stick so that no area remain |
| | | uncovered; 13. Cool SU8 to room temperature - about 50 min. |
| 2 | Spin coat | 1) Set spin-coater with the following settings - Stage 1: 500 RPM, |
| | SU8 | time 5, acceleration 100 - Stage 2: 2000 RPM; time 30; acceleration |
| | | 300. |
| | | 2) Start spin coat by pressing start. |
| 3 | Soft bake | 1) Steps of heating followed by cooling is performed repetibely, once |
| | | for each 10 micrometer thickness of SU8. Heating is performed at |
| | | 100° C. for 10 min, and cooling off is performed on hot plate for 40 |
| | | min. In other words, an 80 micrometer herigh SU8 would need 8 |
| | | cycles of heating and cooling to have good adhesion on glass. |
| 4 | Laser | 1) set focus on the top; 2) Set the user settings as follows - Gain 36 - |
| | exposure | energy 902 mJ/cm² - D step 4 - repeat 2; 3) set focus on the bottom |
| | | and repeat. |
| 5 | Post | 1) Immediately after exposure, the glass slide need to be baked |
| | exposure | directly on the hot plate as follows - 70 C. for 2 minutes, 95° C. for 8 |
| | bake | minutes, and cool down on plate for 40 minutes; 2) a pattern should |
| | | start emerging after step 1; 3) rest the glass slide for 24 hours to |
| | | remove residual stress. |
| 6 | Development | 1) Sonic clean in a flat beaker with SU-8 developer for 1.5 min; 2) If |
| | | valve area is still unclear, do sonic clean for 30 more secs else wrap |
| | | glass slide in kimwipes, add a few drops of SU8 on kimwipes; 3) |
| | | Gently move a cotton swab dipped in SU8 developer on this wrapped |
| | | glass slide along the direction of microchannel; 4) Wash with IPA, DI |
| | | water, dry using nitrogen; 5) Repeat steps 2, 3, 4 till valve is seen |
| | | under a microscope. |
| 7 | Hard Bake | 1) Heat the glass slide on the hot plate with 7° C. heat increase for |
| | (optional). | every 1 min; 2) Keep 100° C. for 3 min; 3) Cool down glass slide at a |
| | | rate of 5° C. per min till 65° C.; 4) At 65 C. switch off the hot plate to |
| | | cool it naturally. |

Phase 1B of Model Fabrication—Acrylic mold for valve. FIG. 7G shows an example of a prepared SU8 valve. FIG. 7H shows the SU8 mold placed in an Acrylic mold. In FIG. 7G, the SU8 mold slide is placed within an acrylic mold so that the mold features are facing up.

The acrylic mold is formed of an Acrylic sheet (thickness 5.4 mm), Superglue (Superglue corporation) using a Laser engraver (LS-1416, BOSS Laser, FL, USA). The design was created using AutoCAD Inventor 2019. It is then converted to “dxf” file format and then to “rld” file format, which is readable by BOSS laser writer.

FIGS. 7I-7K show an example process of fabricating a microvalve acrylic mold for the SU8 valve. FIG. 7I shows the base plate design, and FIG. 7J shows the valve mold housing design to be laser engraved in an acrylic sheet. The base plate in this example is 95 mm×45 mm. The valve plate is a frame of outer dimensions 83.5 mm×33.5 mm and inner dimensions of 76.5 mm×26.5 mm. Once cut, the valve plate is pasted onto the base plate. FIG. 7K shows a finished acrylic mold.

Phase 2—Procedure for Creation of Electrodes. Following the fabrication of the valve mold, gold electrodes can be fabricated on the valve mold. FIG. 7L shows an example design of the gold electrodes. The two leftmost electrodes 702 are for the reservoir. The middle electrode 704 is for the valve. A set of concentric electrodes 706 form the working, reference, and counter electrodes to perform electro-analytical experiments.

Table 5 shows an example process to create the electrode. FIG. 7M shows an example of the fabricated electrodes on the mold.

1TABLE 5

| | Step | Example Embodiment |
|---|---|---|
| 1 | Preparation of | 1) Clean glass slide first using acetone, then methanol or IPA and finally |
| | glass slide for | DI water; 2) Evaporate all liquids by placing it on the hot plate for 1 min |
| | gold deposition | at 115 C.; 3) Cool it down for 2 min on a metal plate; 4) spin coat S1813 |
| | | using the following settings - 4000 RPM, time 30, acceleration 800; 5) |
| | | Bake this S1813 coated glass slide on the hot plate for 1 min at 115 C.; |
| | | 6) Cool it down for 2 min on the metal plate; 7) Use the laser writer to |
| | | write the electrode pattern with laser dose settings at power = |
| | | 190 mJ/cm2; 8) Develop in S1813 developer for 40 sec; 9) Put glass |
| | | slide in DI water bath for 1 min; 10) Dry up using Nitrogen. |
| | Gold | 1) Load the glass slides prepared in earlier steps on the mounting plate |
| | deposition on | upside down in evaporator. Make small pieces of gold and put then in |
| | slides | an evaporation crucible in the evaporator. Put on the glass dome; 2) Put |
| | | the Rough/Backing valve to “Rough”; 3) Put Hi vacuum valve and |
| | | Diffusion pump to OFF; 4) Start the rough pump; 5) When P1 gauge |
| | | shows less than 200 mTorr, switch Rough/Backing valve to Back; 6) On |
| | | P2 reaching less than 200 mTorr, switch Hi Vaccum valve to ON; 7) |
| | | When P2 shows less than 60 mTorr, turn the diffusion pump ON; 8) |
| | | When P1 gauge shows 10 microTorr, start evaporation by turning the |
| | | current ON; 9) After evaporation is done, shut OFF Hi vacuum valve; |
| | | 10) Shut OFF diffusion pump; 11) After 30 min shut OFF |
| | | Rough/Backing valve; 12) Shut off mechanical pump; 13) Take out the |
| | | gold-coated slides and dip them in an acetone bath; 14) Place acetone |
| | | bath in Sonic cleaner and turn it ON for 1.5 minutes; 15) Gold pattern |
| | | emerges. |

Phase 3—Procedure for Preparation of Valve in PDMS. FIG. 7N shows an example microvalve fabricated in PDMS. A Sylgard 184 silicone elastomer base was used with a silicone elastomer curing agent and disposable plastic glass. Table 6 shows an example process to prepare the valve in the PDMS.

TABLE 6

| | |
|---|---|
| 1. | Add elastomer curing agent to elastomer base in a ratio of 1:10. |
| 2) | Mix them thoroughly by stirring using a mixing stick for about 10 min. |
| 3) | Degass for 10 min. |
| 4) | Pour the mixture in an acrylic mold. |
| 5) | Bake in the oven at 70° C. for 20 min and then at 80° C. for 1 hour. |
| 6) | Cool it in the oven for 24 hours for a durable mold (Otherwise, PDMS becomes sticky). |
| 7) | Use a sharp blade to cut out PDMS valve from the mold. If required, gently blow nitrogen |
| | in the cuts. This will remove the valve without tearing the PDMS. |
| 8) | Place the valve in a clean glass slide (see FIG. 7N). |

Procedure for Creation of Valve Assembled on Electrodes. The procedure for the creation of a valve assembled on electrodes utilizes a plasma asher and includes the following steps shown in Table 7. FIG. 7O shows an image of a fabricated valve.

TABLE 7

| | |
|---|---|
| 1) | Start the flow of water in the cooling system of the Plasma asher. |
| 2) | Start oxygen flow to the Plasma asher. |
| 3) | Start the vacuum pump. |
| 4) | Switch ON the plasma asher. |
| 5) | Switch ON the digital display for the vacuum. |
| 6) | Keep the sample in the plasma chamber, electrode side facing up. Close the lid by |
| | unscrewing the pin and simultaneously pressing the cover lid down. |
| 7) | Let the vacuum settle for a value of close to 0.25, power = 50, and keep the pressure on the |
| | gauge close to 45. |
| 8) | Toggle the oxygen switch to ON. This increases pressure in the chamber. Let it settle back |
| | to the earlier value of close to 0.25, and pressure on the gauge as before at close to 45. |
| 9) | Start plasma for the required amount of time by throwing generator switch to ON. |
| 10) | After the time duration switch OFF plasma but keep oxygen ON for 1 min. |
| 11) | Switch OFF oxygen, switch ON venting for 1 minute. |
| 12) | Turn back screw to release the vacuum - the lid will pop in about 30 sec. |
| 13) | After the lid pops wait for 1 min. |
| 14) | Place the PDMS valve on electrode glass slide, ensuring that the valve is aligned with the |
| | electrode. |
| 15) | The cleaned surface on electrodes will bind with PDMS. |
| 16.) | The valve is now ready for use. |

Testing the Valve. Tests were performed to verify the structure and function of the constructed valve. KCl (1M) was prepared by dissolving the required quantity of KCl in DI water. Phosphate Buffer Solution (PBS), Gmop, Foetal Buffer Solution (FBS), and Cell culture solution were procured. Each of these was dyed using 10 drops of food color.

FIG. 7P shows the fully constructed system with gold electrodes and valve, including the connections. The negative terminal is connected to the valve electrode, and the positive terminal is connected to the reservoir electrode. The valve was placed on a acrylic elevation platform which was on a precision XY-axis movement table. The screws on the XY movement table were turned to bring the valve under the lens of a USB microscope.

Experiments conducted revealed various properties that would enhance the valve's function, including the plasma treatment duration time needed to achieve valve action, retention probability for each width, the voltage at which the valve would operate, and the corresponding valve width.

Table 8A shows a method to find the plasma treatment duration needs to achieve valve action.

TABLE 8A

| | |
|---|---|
| 1) | Do plasma treatment (minimum plasma treatment time that gets |
| | the movement) on gold |
| | electrodes for duration 5 min, 2.5 min, 1 min, 30 sec. |
| 2) | Insert fluid into the reservoir chamber using a pipette. |
| 3) | Apply potential at the valve with respect to the reservoir electrode |
| | in steps of −0.1 V. |
| 4) | Check if liquid moves beyond the valve on the application of |
| | potential. |

Table 8B shows a method to find the retention probability for each width.

TABLE 8B

| | |
|---|---|
| 1) | Do the plasma treatment on gold electrodes for the minimum time |
| | found in the earlier step. |
| 2) | Insert fluid at the reservoir chamber using a pipette. |
| 3) | Fluid starts flowing towards the valve due to hydrophilic glass. |
| 4) | Check and note if the flow stops at the valve for each valve width. |

Table 8C shows a method to find the voltage at which the valve worked and the corresponding valve width.

TABLE 8C

| | |
|---|---|
| 1) | Do the plasma treatment on gold electrodes for the minimum time |
| | found in the earlier step. |
| 2) | Apply potential at the valve (that gets the movement across the |
| | valve) with respect to the reservoir electrode in steps of −0.1 V. |
| 3) | Check if liquid moves at each voltage. |

### EXPERIMENTAL RESULTS AND ADDITIONAL EXAMPLES

FIG. 8A shows experimental images of fluid moving on the microfluidic chip, according to one implementation. FIG. 8A shows five steps of a bead method DNA isolation sequence 800. In this sequence 800, DNA was isolated using a custom magnetic bead-based protocol. Using an EWOD system (e.g., the cartridge and microfluidic electrode assembly of FIG. 1A), buffers and samples were loaded into the reservoirs using a pipette. A program containing the appropriate sequences to complete the protocol was loaded onto the device and executed (e.g., instructions stored on a cartridge, communicated to a base system, and performed, as described in FIG. 1A).

At step 801, one volume of sample was moved to the mixing area. At step 802, the magnetic beads were moved to the mixing area and (at step 803) mixed with the sample. Finally, at step 804, the full volume of the mixture was moved over the magnet in the capture area. After letting the beads settle over the magnet, at step 805, excess liquid was moved to the waste reservoir, leaving bound DNA over the magnet. Finally, the elution buffer was moved through the capture area into the output reservoir (step 805).

FIGS. 8B and 8C illustrate flowcharts and diagrams describing the operation of an experimental prototype. For example, FIG. 8B shows an overview of the device design. The main device functions and control are handled by a microcontroller (Atmel ATmega328). The device also contains 2 Mb (M95M02) Electrically Erasable Programmable Read-Only Memory (EEPROM) large enough to store a number of assay protocols such that the user can select the appropriate pre-set program for the given disposable EWOD chip. The memory allows the user to have multiple assay-specific chips on hand to increase the device's capability in the field. The microcontroller displays a menu of all assay protocols loaded onto the device via an Organic Light Emitting Diode (OLED) screen. Menu navigation and protocol selection are made through the onboard keypad. Once a protocol has been selected by the user, the microcontroller fetches the first sequence of the protocol from the EEPROM and transfers it to onboard high-voltage drivers (HV507), which activate the appropriate pads. The microcontroller then waits for the appropriate voltage to be reached by the droplet position feedback system before fetching the next sequence from memory. Due to the manufacturing variations, the droplet feedback system adaptively controls the output voltage to the appropriate pads to ensure that the target droplet is moved to the desired location. This process is repeated until the entire protocol has been processed.

The programs stored in memory can be managed through custom software on a PC and downloaded to the device via a Universal Serial Bus (USB) port. Another microcontroller is incorporated into the system to translate the USB packets and store them into the EEPROM. Additionally, an integrated on-board power supply capable of output voltage up to 200 V is incorporated into the system to offer the capability of moving a wider range of liquid types. Finally, to maximize portability, the entire system is powered from an integrated lithium ion battery which provides up to 80 h of active run time and over 300 h in standby. The battery can be recharged via a USB port.

To keep the firmware of the main controller light, the PC software populates the EEPROM with a specific format such that the protocols can be called back easily by the microcontroller. When the device is first powered on, a splash screen is displayed while the microcontroller sets up its peripherals. Once ready, the Protocol Select menu is displayed, where the user can navigate to the desired protocol. During the execution of the selected protocol, the display shows protocol progress. Additionally, the user can stop the active protocol through the keypad, where the user is prompted to confirm the request. If the request to cancel the protocol is confirmed, the user is taken back to the Protocol Select menu. FIG. 8C shows the control flow once a stored protocol has been selected, according to a prototypical implementation.

FIG. 8D shows images of manufactured experiential microfluidic chips. The lower layer of the chip containing the EWOD is shown (e.g., the set of conductive tiles on the fluidic plate of the microfluidic electrode assembly of the cartridge of FIG. 1A).

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

What is claimed:

1. A system comprising:
a base system;
a cartridge to couplable to the base system, wherein the cartridge includes:
housing;
a microfluidic electrode assembly comprising:
a fluidic plate having two or more mixing/testing regions;
a set of conductive tiles disposed along the fluidic plate that connects between the two or more mixing/testing regions, wherein the set of conductive tiles (e.g., pads) terminates at a set of corresponding conductive-tile array located at an interface region on the fluidic plate;
a self-testing circuit having electronics configured to assess operative contact between (i) the conductive-tile array and (ii) driving circuits configured to actuate the set of conductive tiles to move or mix fluid along the fluidic plate.

2. The system of claim 1 further comprising at least one sensing tile disposed along the fluidic plate adjacent to or integrated with the set of conductive tiles, wherein the at least one sensing tile terminates either (i) at the set of corresponding conductive-tile array or (ii) a second set of conductive-tile array, the self-testing circuit being configured to also assess operative contact of the conductive-tile array associated with the sensing tile.

3. The system of claim 1 further comprising a biosensor disposed (i) along the fluidic plate between two or more conductive tiles of the set of conductive tiles or (ii) inside one of the two or more mixing/testing regions, wherein the biosensor electrically terminates either (i) at the set of corresponding conductive-tile array or (ii) a second set of conductive-tile array, the self-testing circuit being configured to also assess operative contact of the conductive-tile array associated with the biosensor.

4. The system of claim 1 further comprising a dielectric material disposed between elements of the set of conductive tiles.

5. The system of claim 1 further comprising a magnetic focusing region for the fluidic plate or the set of conductive tiles, the magnetic focusing region being defined by a field from a magnet and a magnetic focusing structure disposed adjacent or in proximity to the magnetic region.

6. The system of claim 5 wherein the magnetic focusing structures comprises a magnetic field guide.

7. The system of claim 1, wherein the two or more mixing/testing regions comprises a sample reservoir, an outlet reservoir, and at least one intermediate reservoir, each disposed adjacent to or along the set of conductive tiles or the interface region of the fluidic plate.

8. The system of claim 7, wherein the at least one intermediate reservoir comprises a pre-configured buffer solution to be introduced into one of the two or more mixing/testing regions.

9. The system of claim 7, wherein the at least one intermediate reservoir comprises a reagent to be introduced into one of the two or more mixing/testing regions for mixing with the sample solution.

10. The system of claim 7, wherein the at least one intermediate reservoir comprises an intermediate buffer solution.

11. The system of claim 7, wherein one of the sample reservoir, the outlet reservoir, or the at least one intermediate reservoir is adjacent to the interface region on the fluidic plate.

12. The system of claim 1 further comprising an electrically-actuated non-mechanically moving valve disposed (i) along the set of conductive tiles or (ii) mixing/testing regions, the electrically-actuated non-mechanically moving valve configured to restrict a fluid flow across the valve in a natural unactuated state and allow flow of fluid across the valve when actuated.

13. The system of claim 1, the base system comprising:
a microcontroller in electrical communication with the cartridge; and
a memory in electrical communication with the microcontroller; and
a display interface and/display in electrical communication with the microcontroller and configured to display information about the system.

14. The system of claim 7, wherein the intermediate reservoir includes an integrated package assembly disposed on the fluidic plate, the integrated package assembly having (i) a first region to hold a reagent or fluid and (ii) a second region to hold an intermediate storage fluid, the integrated package assembly having a removable or pierceable covering configured, (i) in a non-removed or non-pierced state, to maintain negative pressure at the first region and (ii) in a removed or pierced state to allow the storage fluid to move to the first region while the reagent or fluid move to the second region to contact the fluidic plate.

15. The system of claim 7, wherein the system is configured to perform one of: (i) a DNA isolation protocol with an immobilized filter, or (ii) a DNA isolation protocol with magnetic beads.

16. A method for self-testing a circuit, the method comprising:
providing a cartridge comprising a microfluidic electrode assembly comprising fluidic plate and a set of conductive tiles disposed along the fluidic plate;
inserting the cartridge into a base system;
assessing operative contact between one of (i) the microfluidic electrode assembly of the cartridge or (ii) the set of conductive tiles and corresponding contact points on the base system; and
signaling an error if one or more contact points are disconnected or incompletely connected to the microfluidic electrode assembly cartridge.

17. The method of claim 16, wherein the assessing is performed during a run-time of the cartridge.

18. The method of claim 16, wherein the assessing is performed during a manufacturing step of the cartridge

19. The method of claim 16, further comprising:
recycling or reusing a cartridge upon completion of a testing operation.

20. A cartridge configured to couple to a base system, the cartridge comprising:
a housing;
a microfluidic electrode assembly comprising:
a fluidic plate having two or more mixing/testing regions;
a set of conductive tiles disposed along the fluidic plate that connects between the two or more mixing/testing regions, wherein the set of conductive tiles terminates at a set of corresponding conductive-tile array located at an interface region on the fluidic plate;
a self-testing circuit having electronics configured to assess operative contact between (i) the conductive-tile array and (ii) driving circuits configured to actuate the set of conductive tiles to move or mix fluid along the fluidic plate.
